(19) United States
(12) Patent Application Publication
(10) Pub. No.: US 2026/0152676 A1
(43) Pub. Date: Jun. 4, 2026

(54) ADHESIVE COMPOUND, ADHESIVE TAPE, BONDED ASSEMBLY, AND METHOD FOR ELECTRICALLY DEBONDING THE BONDED ASSEMBLY

(71) Applicant: tesa SE, Norderstedt (DE)

(72) Inventors: Hesham Abdeldaim, Hamburg (DE); Eugen Fomenko, Norderstedt (DE); Ingo Neubert, Norderstedt (DE); Kai Ellringmann, Hamburg (DE)

(73) Assignee: tesa SE, Norderstedt (DE)

(21) Appl. No.: 19/406,009

(22) Filed: Dec. 2, 2025

(30) Foreign Application Priority Data
Dec. 3, 2024 (DE) 102024135803.3

(51) Int. Cl. C09J 11/06; B32B 43/00; C09J 5/00; C09J 7/38; C09J 9/02

(52) U.S. Cl. CPC C09J 11/06; B32B 43/006; C09J 5/00; C09J 7/385; C09J 9/02; C09J 2203/37; C09J 2301/124; C09J 2301/314; C09J 2301/408; C09J 2301/414; C09J 2301/502

(57) ABSTRACT

The invention relates to an adhesive compound, to an adhesive tape, to a bonded assembly, to a method for electrically debonding the bonded assembly, and to the use of the adhesive compound or adhesive tape for bonding components in electronic devices, automobiles, medical devices and dental devices. The adhesive compound comprises a) at least one first ionic liquid which has a pH of less than or equal to 7, and b) at least one second ionic liquid which has a pH of greater than 7, wherein a pure mixture of all ionic liquids contained in the adhesive compound and a) having a pH of less than or equal to 7 and b) having a pH of greater than 7 has a pH of 5.5 to 9.

The invention relates to an adhesive compound, to an adhesive tape, to a bonded assembly, to a method for electrically debonding the bonded assembly, and to the use of the adhesive compound or adhesive tape for bonding components in electronic devices, automobiles, medical devices and dental devices.

In recent times there has been increased interest in “debonding-on-demand” functionalities, this being driven by environmental legislation and end-customer awareness of sustainability and by increasing cost pressures in production. The use scenarios for debonding processes are classified into rework, repair, recycling, and processing aids.

Debonding technologies aim to achieve a cohesive split in the adhesive layer or an adhesive detachment of the adhesive layer from the substrate. Whereas the former necessitates cleaning the substrate before rebonding, in the latter case this is not required.

However, adhesive debonding technologies that guarantee the required high and enduringly reliable bond strength are generally relatively difficult to realize or their application, for example detachment using an infiltrating solvent, is very time-consuming.

For instance, particularly in the rework or repair of electronic devices, such as smartphones and tablet computers, it is predominantly cohesively splitting adhesive bonds that are currently employed, often in the form of pressure-sensitive adhesive tapes, the cohesion of which is reduced by an increase in temperature to such an extent that manual, cohesive separation of the bond can take place. This results in extensive rework to prepare the substrate surface contaminated with adhesive residues for rebonding.

In addition to heat-mediated separation methods, electrical separation methods are being discussed.

WO 2023175424 A1 discloses the reduction in the peel adhesion of an adhesive compound through application of a voltage, wherein the adhesive compound contains an ionic liquid, polymeric microballoons based on polar monomers, and a polymer matrix based on macromers and optionally polar monomers, such as acrylamides. The examples appear to show good corrosion characteristics after storage for up to 3 days at 65° C. and 90% relative humidity. After application of a voltage of 50 V for 60 s, 180 s or 300 s, a reduction in the bond strength of 61% to 93% is achieved.

The ionic liquids of WO 2023175424 A1 used in the corresponding examples, which show the stated effects, have a pH in the acidic range, i.e. less than 7. This also applies to the disclosed mixture with the name FC-5000.

WO 2021202527 A1 also discloses a mixture of two ionic liquids in an electrically debondable adhesive compound. The combination of two different anions is disclosed, namely an alkylsulfonate and a sulfonylimide. For this, in the working example, 1-ethyl-3-methylimidazolium bis(trifluoromethylsulfonyl)imide (EMIM-TFSI) and 1-ethyl-3-methylimidazolium methanesulfonate (EMIM-MeSO₃) are used, with both ionic liquids and thus also the mixture thereof having a pH of less than 7.

US2024263044 A1 likewise discloses an acidic mixture of two ionic liquids in an electrically debondable adhesive compound.

The influence on the corrosion characteristics after prolonged storage under hot and humid conditions is not disclosed in the two texts.

In connection with and in addition to the corrosion characteristics, it is also desirable that during the production and use of the electrically debondable adhesive tape, there is no decomposition of the constituents contained therein, in particular the ionic liquids. In the case of fluorine-containing ionic liquids, the release of hydrofluoric acid (HF) in particular is exceptionally undesirable.

The object of the present invention is to provide an adhesive compound which, compared to the prior art, allows a greater reduction in the peel adhesion by application of a voltage. The adhesive compound should therefore be easier to detach electrically and at the same time have a high initial peel adhesion. At the same time, redetachment should be achievable as easily and cleanly as possible.

Another object is to optimize the storage stability of such an adhesive compound, especially under hot and humid conditions. The adhesive compound here should be able to be used in combination with metallic carriers and should contribute to reduced corrosion of the metallic carrier. In particular, no undesirable substances, and in particular no hydrofluoric acid, should be released here.

A supplementary object is to provide a corresponding advantageous adhesive tape.

It is an additional object to specify a bonded composite and a method for redetaching the adhesive bond produced by the adhesive compound or adhesive tape.

In addition, it is an object of the invention to provide for a use of the provided adhesive compounds or adhesive tapes for the bonding of two or more substrates.

The above objects are achieved by the subject matter of the invention as defined in the claims. Preferred configurations of the invention result from the further dependent claims and from the statements hereinafter.

Embodiments that are hereinafter designated as preferred are in particularly preferred embodiments combined with features of other embodiments designated as preferred. Very particular preference is therefore given to combinations of two or more of the embodiments designated hereinafter as particularly preferred. Preference is likewise given to embodiments in which a feature of one embodiment designated as preferred to any extent is combined with one or more further features of other embodiments designated as preferred to any extent. The invention thus encompasses combinations of individual features with one another and also with different levels of preference in said combinations. Thus the invention encompasses for example the combination of a first feature designated as “preferred” with a second feature designated as “particularly preferred”. Features of preferred adhesive tapes, bonded composites, and also uses and methods arise from the features of preferred adhesive compounds. Features of preferred bonded composites, uses, and methods also arise from the features of preferred adhesive tapes.

The adhesive compound of the invention comprises
a) at least one first ionic liquid which has a pH of less than or equal to 7, and
b) at least one second ionic liquid which has a pH of greater than 7,
wherein a pure mixture of all ionic liquids contained in the adhesive compound and a) having a pH of less than or equal to 7 and b) having a pH of greater than 7 has a pH of 5.5 to 9.

The expression “at least one” or the equivalent “one or more” refers, in a manner usual in the sector, to the chemical nature of the entity in question and not to the amount of substance thereof. It is clear to the skilled person that the expression “an ionic liquid” therefore refers to a multiplicity of anions and cations.

By means of the ionic liquids present, it is possible even after bonding, by application of a voltage, to electrically debond the adhesive compound.

It has surprisingly emerged that the adhesive compound according to the invention—containing a mixture of at least two ionic liquids, of which one has an acidic to neutral pH, i.e., pH less than or equal to 7, and the other has a basic pH, i.e., greater than 7, where the pure mixture of the ionic liquids has a pH of 5.5 to 9—can be detached again without applying great force from bonded substrates electrically, by application of a voltage, in a simple, clean and fast way, with the reduction in peel adhesion resulting from the applied voltage being improved compared to the prior art, in particular in comparison to WO 2023175424 A1. The adhesive compound of the invention here shows a surprisingly high storage stability even under hot and humid conditions for up to 7 days. Adhesive tapes comprising the adhesive compound of the invention and metallic components, such as one or more metallic carrier layers, show improved corrosion characteristics of the metallic layer(s). At the same time, no undesirable substances, especially no hydrofluoric acid, are released.

The adhesive compound of the invention is elucidated more particularly hereinbelow.

The adhesive compound contains a) at least one first ionic liquid which has a pH of less than or equal to 7, and
b) at least one second ionic liquid which has a pH of greater than 7,
wherein a pure mixture of all ionic liquids contained in the adhesive compound and a) having a pH of less than or equal to 7 and b) having a pH of greater than 7 has a pH of 5.5 to 9.

Ionic liquids in the context of the present invention are salts which are liquid at 100° C. and preferably at room temperature, i.e., 23° C. Ionic liquids accordingly contain anions and cations.

Ionic liquids which are liquid at 100° C. but solid at 23° C. are made processible preferably by suitable process steps, such as in particular and for example by dissolution in a solvent. Ionic liquids which are liquid at 23° C. are preferred.

When a voltage is applied, the anions migrate to the anode side and the cations migrate to the cathode side. Without wishing to be limited thereto, it can be mechanistically assumed that this causes a reduction in the peel adhesion of the adhesive compound comprising the ionic liquid to at least one substrate, thereby achieving an adhesive split between the adhesive compound and the at least one substrate.

In the context of the present invention, the ionic liquids having a pH of less than or equal to 7 are also referred to as “ionic liquid a)”.

In the context of the present invention, the ionic liquids having a pH of greater than 7 are also referred to as “ionic liquid b)”.

By a pure mixture of all ionic liquids a) and b) contained in the adhesive compound is meant in particular that these ionic liquids are in homogeneous mixture with one another and so a pH of the mixture can be determined. According to the invention, this mixture pH is 5.5 to 9, preferably 6.5 to 9, in turn preferably from 7 to 9, more preferably from 7 to 8.5, and very preferably from 7.3 to 8.2. In particular, the pH value of the stated mixture is 7.5 to 8.

With the stated preferred pH ranges, the underlying object of the invention is achieved with further optimization in accordance with the preference levels and/or the more closely specified ranges.

Preferred is an adhesive compound of the invention which comprises as first ionic liquid a) an ionic liquid having a pH of less than or equal to 7, wherein this ionic liquid a) comprises an imidazolium-based cation.

Preferred is an adhesive compound of the invention which comprises as first ionic liquid a) an ionic liquid having a pH of less than or equal to 7, wherein this ionic liquid a) comprises an anion selected from the group consisting of the anions hexafluorophosphate (PF₆⁻), bis(trifluoromethylsulfonyl)imide (CF₃SO₂) ₂N⁻, TFSI), bis(fluorosulfonyl)imide ((FSO₂) ₂N⁻, FSI), trifluoromethanesulfonate (CF₃SO₃⁻, OTF, triflate), acetate (CH₃COO⁻), methylsulfate (CH₃OSO₃⁻), tetrafluoroborate (BF₄⁻), thiocyanate (SCN⁻), benzoate and dicyanamide (N(CN)₂⁻).

Particularly preferred is an adhesive compound of the invention which comprises as first ionic liquid a) an ionic liquid having a pH of less than or equal to 7, wherein this ionic liquid a) further comprises an anion selected from the group consisting of the anions hexafluorophosphate (PF₆⁻), bis(fluorosulfonyl)imide ((FSO₂) ₂N⁻, FSI), tetrafluoroborate (BF₄⁻), benzoate and dicyanamide (N(CN)₂⁻).

Very preferred is an adhesive compound of the invention which comprises as first ionic liquid a) an ionic liquid having a pH of less than or equal to 7, wherein this ionic liquid a) further comprises an anion selected from the group consisting of the anions hexafluorophosphate (PF₆⁻) and bis(fluorosulfonyl)imide ((FSO₂) ₂N⁻, FSI), of which hexafluorophosphate (PF₆⁻) is preferred in turn.

Preferred is an adhesive compound of the invention which comprises as first ionic liquid a), and thus as an ionic liquid having a pH of less than or equal to 7, at least one ionic liquid selected from the group consisting of
1-butyl-3-methylimidazolium hexafluorophosphate (BMIM-PF₆; CAS No. 174501-64-5),
1-butyl-3-methylpyridinium hexafluorophosphate (BMPY-PF₆; CAS No. 845835-03-2),
1-butyl-2,3-dimethylimidazolium bis(trifluoromethylsulfonyl)imide (BDiMIM-TFSI, CAS No. 350493-08-2),
1-butyl-3-methylimidazolium bis(trifluoromethylsulfonyl)imide (BMIM-TFSI; CAS No. 174899-83-3),
1-ethyl-3-methylimidazolium bis(trifluoromethylsulfonyl)imide (EMIM-TFSI; CAS No. 174899-82-2),
1-ethylimidazolium bis(trifluoromethylsulfonyl)imide (EIM-TFSI; CAS No. 353239-10-8),
1-methyl-3-propylimidazolium bis(trifluoromethylsulfonyl)imide (PMIM-TFSI; CAS No. 216299-72-8),
1,3-diethylimidazolium bis(trifluoromethylsulfonyl)imide (DIEIM-TFSI; CAS No. 174899-88-8),
1-ethyl-2,3-dimethylimidazolium bis(trifluoromethylsulfonyl)imide (EDiMIM-TFSI; CAS No. 174899-90-2),
1-allyl-3-methylimidazolium bis(trifluoromethylsulfonyl)imide (AllyIMIM TFSI; CAS No. 655249-87-9),
1-ethyl-3-vinylimidazolium bis(trifluoromethylsulfonyl)imide (EVIM-TFSI; CAS No. 204854-22-8),
1-methyl-1-propylpyrrolidinium bis(trifluoromethylsulfonyl)imide (Pyr13-TFSI; CAS No. 223437-05-6),
1-butyl-1-methylpyrrolidinium bis(trifluoromethylsulfonyl)imide (Pyr14-TFSI; CAS No. 223437-11-4),
1-ethyl-4-methylpyridinium bis(trifluoromethylsulfonyl)imide (Et4Pic-TFSI; CAS No. 712355 03-8),
diethylmethylsulfonium bis(trifluoromethylsulfonyl)imide (S122-TFSI; CAS No. 792188-85-3), triethylsulfonium bis(trifluoromethylsulfonyl)imide (S222-TFSI; CAS No. 321746-49-0),
1-butyl-4-methylpyridinium bis(trifluoromethylsulfonyl)imide (Bu4Pic-TFSI; CAS No. 475681-62-0),
1-butyl-3-methylpyridinium bis(trifluoromethylsulfonyl)imide (BMPY-TFSI; CAS No. 344790-86-9),
2-methyl-1-propylpyridinium bis(trifluoromethylsulfonyl)imide (Pro2Pic-TFSI; CAS No. 1456877-99-8),
1-propyl-4-methylpyridinium bis(trifluoromethylsulfonyl)imide (Pro4Pic-TFSI; CAS No. 1456878-01-5), 1-hexylpyridinium bis(trifluoromethylsulfonyl)imide (HexPy-TFSI; CAS No. 460983-97-5),
1-ethyl-3-methylimidazolium bis(fluorosulfonyl)imide (EMIM-FSI; CAS No. 235789-75-0),
1-butyl-3-methylimidazolium bis(fluorosulfonyl)imide (BMIM-FSI; CAS No. 1235234-58-8),
1-ethyl-3-methylimidazolium trifluoromethanesulfonate (EMIM-OTf, alternative name:
1-ethyl-3-methylimidazolium triflate, CAS No. 145022-44-2),
1-butyl-3-methylimidazolium trifluoromethanesulfonate (BMIM-OTf, alternative name:
1-butyl-3-methylimidazolium triflate, CAS No. 174899-66-2),
1-butyl-3-methylimidazolium acetate (BMIM-OAc; CAS No. 284049-75-8),
1-butyl-3-methylimidazolium benzoate (BMIM benzoate; CAS No. 635312-83-3),
1,3-dimethylimidazolium methylsulfate (DiMIM-MeSO₄; CAS No. 97345-90-9),
1-butyl-3-methylimidazolium methylsulfate (BMIM-MeSO₄; CAS No. 401788-98-5),
1-ethyl-3-methylimidazolium tetrafluoroborate (EMIM-BF₄; CAS No. 143314-16-3),
1-butyl-3-methylimidazolium tetrafluoroborate (BMIM-BF₄; CAS No. 174501-65-6),
1-hexyl-3-methylimidazolium tetrafluoroborate (HMIM-BF₄; CAS No. 244193-50-8),
1-decyl-3-methylimidazolium tetrafluoroborate (DMIM-BF₄; CAS No. 244193-56-4),
1-methylimidazolium tetrafluoroborate (MIM-BF₄; CAS No. 151200-14-5),
1-ethyl-3-methyl-imidazolium thiocyanate (EMIM-SCN; CAS No. 331717-63-6) and
1-allyl-3-methylimidazolium dicyanamide (AllyIMIM-DCA; CAS No. 917956-73-1).

More preferred is an adhesive compound of the invention which comprises as first ionic liquid a), and thus as an ionic liquid having a pH of less than or equal to 7, at least one ionic liquid selected from the group consisting of
1-butyl-3-methylimidazolium hexafluorophosphate (BMIM-PF₆; CAS No. 174501-64-5),
1-ethyl-3-methylimidazolium bis(fluorosulfonyl)imide (EMIM-FSI; CAS No. 235789-75-0),
1-butyl-3-methylimidazolium bis(fluorosulfonyl)imide (BMIM-FSI; CAS No. 1235234-58-8) and
1-butyl-3-methylimidazolium benzoate (BMIM benzoate; CAS No. 635312-83-3).

Very preferred is an adhesive compound of the invention which comprises as first ionic liquid a), and thus as an ionic liquid having a pH of less than or equal to 7, at least one ionic liquid selected from the group consisting of
1-butyl-3-methylimidazolium hexafluorophosphate (BMIM-PF₆) and
1-ethyl-3-methylimidazolium bis(fluorosulfonyl)imide (EMIM-FSI; CAS No. 235789-75-0).

More preferably, the pH of the first ionic liquid is less than 7.

More preferably, 1-butyl-3-methylimidazolium hexafluorophosphate (BMIM-PF₆) is included as first ionic liquid a).

Preferred is an adhesive compound of the invention which comprises as second ionic liquid b) an ionic liquid having a pH of greater than 7, wherein this ionic liquid b) comprises a cation selected from the group consisting of imidazolium-based cations and pyrrolidinium-based cations.

Preferred is an adhesive compound of the invention which comprises as second ionic liquid b) an ionic liquid having a pH of greater than 7, wherein this ionic liquid b) further comprises an anion selected from the group consisting of the anions acetate (CH₃COO⁻), ethylsulfate (CH₃CH₂OSO₃⁻), diethylphosphate, octanoate, benzoate, tricyanomethanide (C(CN)₃⁻) and dicyanamide (N(CN)₂⁻).

More preferred is an adhesive compound of the invention which comprises as second ionic liquid b) an ionic liquid having a pH of greater than 7, wherein this ionic liquid b) comprises an anion selected from the group consisting of the anions diethylphosphate, ethylsulfate, benzoate and dicyanamide (N(CN)₂⁻), of which dicyanamide (N(CN)₂) is preferred in turn.

Preferred is an adhesive compound of the invention which comprises as second ionic liquid b), and thus as an ionic liquid having a pH of greater than 7, at least one ionic liquid selected from the group consisting of
1-ethyl-3-methylimidazolium dicyanamide (EMIM-N(CN)₂, EMIM-DCA; CAS No. 370865-89-7),
1-butyl-3-methylimidazolium dicyanamide (BMIM-DCA; CAS No. 448245-52-1),
1-butyl-1-methylpyrrolidinium dicyanamide (Pyr14-DCA; CAS No. 370865-80-8), N-butyl-N-methylpyrrolidinium tricyanomethanide (Pyr14-TCM; CAS No. 878027-72-6),
1-butyl-3-methylimidazolium tricyanomethanide (BMIM-TCM; CAS No. 878027-73-7),
1-ethyl-3-methylimidazolium acetate (EMIM-OAc; CAS No. 143314-17-4),
1-ethyl-3-methylimidazolium octanoate (EMIM-Oct; CAS No. 1154003-55-0),
1-ethyl-3-methylimidazolium diethyl phosphate (EMIM-DEP; CAS No. 848641-69-0),
1-ethyl-3-methylimidazolium benzoate (EMIM benzoate; CAS No. 150999-33-0) and
1-ethyl-3-methylimidazolium ethylsulfate (EMIM-EtSO₄; CAS No. 342573-75-5).

Preferred is an adhesive compound of the invention which comprises as second ionic liquid b), and thus as an ionic liquid having a pH of greater than 7, at least one ionic liquid selected from the group consisting of
1-ethyl-3-methylimidazolium dicyanamide (EMIM-N(CN)₂), 1-ethyl-3-methylimidazolium benzoate, 1-ethyl-3-methylimidazolium diethylphosphate and 1-ethyl-3-methylimidazolium ethylsulfate.

Included more preferably as second ionic liquid b) is 1-ethyl-3-methylimidazolium dicyanamide (EMIM-N(CN)₂).

The proportions of first ionic liquids a) contained in the adhesive compound to second ionic liquids b) contained in the adhesive compound are selected such that the pure mixture of these ionic liquids has the pH value desired according to the invention, including all preference levels.

More preferably, the adhesive compound comprises a mixture of the ionic liquids 1-butyl-3-methylimidazolium hexafluorophosphate and 1-ethyl-3-methylimidazolium dicyanamide. Preferably, the ratio of the amount of 1-butyl-3-methylimidazolium hexafluorophosphate to the amount of 1-ethyl-3-methylimidazolium dicyanamide is 70% to 80% by weight of 1-butyl-3-methylimidazolium hexafluorophosphate to 20% to 30% by weight of 1-ethyl-3-methylimidazolium dicyanamide, with the sum of the amounts of the two ionic liquids making 100% by weight.

The adhesive compound of the invention comprises preferably 0.05 to 15 parts by weight, more preferably 0.1 to 15 parts by weight, very preferably 2.5 to 15 parts by weight, in turn preferably 2.5 to 11 parts by weight, of ionic liquids, based on 100 parts by weight of polymers, more particularly poly(meth)acrylates, that are contained in the adhesive. The amounts indicated represent the total amounts of all ionic liquids a) and b) included.

With such amounts, comparatively rapid electrical detachment is made possible without at the same time any adverse effect on the adhesion of the adhesive compound to in particular at least one substrate prior to detachment.

In the production of the adhesive compound of the invention, a homogeneous mixture of the ionic liquids a) and b) is preferably first prepared. The mixture consists of the ionic liquids a) and b). The pH of this homogeneous mixture in particular is determined as described in the Methods section.

In principle, the adhesive compound of the invention may contain, in addition to the ionic liquids described, any constituents which do not, or not significantly, negatively impact the electrical detachability effect.

It follows from the term “adhesive compound” that constituents are included which make the compound tacky and thus in particular enable flow onto a substrate and/or which can adhere in any other way to the surface of a substrate and in so doing have a sufficient inherent strength and bond strength to the substrate, optionally after curing.

Preferably, the adhesive compound comprises at least one polymer for this purpose.

More preferably, the adhesive compound of the invention comprises at least one poly(meth)acrylate.

A “poly(meth)acrylate” is understood to be a polymer obtainable preferably by radical polymerization of acrylic and/or methacrylic monomers and optionally further copolymerizable monomers. In particular, a “poly(meth)acrylate” is understood to be a polymer whose monomer basis consists to an extent of at least 50% by weight of acrylic acid, methacrylic acid, acrylic esters and/or methacrylic esters, where acrylic esters and/or methacrylic esters are present at least proportionally, preferably to an extent of at least 30% by weight, based on the total monomer basis of the polymer concerned.

Preferred is an adhesive compound of the invention which comprises at least one poly(meth)acrylate, wherein the poly(meth)acrylate is prepared by polymerization of a monomer composition containing more than 15% by weight of one or more nitrogen-containing monomers.

The more than 15% by weight of the nitrogen-containing monomers are not automatically included among the at least 50% by weight which define a “poly(meth)acrylate”, since the invention also embraces nitrogen-containing monomers which are not (meth)acrylates. In these cases, in addition to the 15% by weight of nitrogen-containing non-(meth)acrylates, the monomer composition contains at least 50% by weight of acrylic acid, methacrylic acid, acrylic esters and/or methacrylic esters.

In the preferred case where the at least one nitrogen-containing monomer is at least one nitrogen-containing (meth)acrylate monomer, preferably the more than 15% by weight of the nitrogen-containing (meth)acrylate monomers as acrylic esters and/or methacrylic esters represent a part of the at least 50% by weight which define a “poly(meth)acrylate”.

However, in particularly preferred embodiments of the invention, all monomers of the monomer composition are acrylic acid, methacrylic acid, acrylic esters and/or methacrylic esters, in which case more than 15% by weight of the monomers contained are nitrogen-containing (meth)acrylate monomers.

The at least one poly(meth)acrylate preferably included is the base polymer in the adhesive compound. All amounts of further constituents are based on the total amount of poly(meth)acrylates, as already explained above for the ionic liquids.

Thus the at least one poly(meth)acrylate in particular also represents the main constituent of the adhesive compound of the invention.

According to preferred embodiments of the invention, the total amount of poly(meth)acrylates in the adhesive compound is 60% to 97% by weight, preferably 70% to 97% by weight, based on the total weight of the adhesive compound.

As usual, “% by weight” here stands for percent by weight. All figures in % by weight which relate to the monomers of the monomer composition from which the poly(meth)acrylate is produced are based on the total weight of the monomer composition, where only the monomers are considered and other substances, such as crosslinkers and initiators, do not contribute to the total weight of the monomer composition on which the indication “% by weight” is based.

The glass transition temperature, determined by DSC as described in the Test Methods section under “DSC”, of the at least one poly(meth)acrylate is preferably <8° C. (less than eight degrees Celsius), more preferably between +5 and −65° C. (between plus five degrees and minus sixty-five degrees Celsius).

This produces particularly good flow-on behavior on the part of the adhesive compound. In addition, it is possible within the stated glass transition temperature range to add further additives, such as tackifier resins, and to maintain the desired properties, such as tackiness in particular.

The glass transition temperature of the poly(meth)acrylate is determined predominantly through the choice of monomers.

Preferably, the monomer composition contains more than 15% by weight of one or more nitrogen-containing monomers and thus at least one nitrogen-containing monomer.

A “nitrogen-containing monomer” is understood here to be a chemical compound which bears at least one functional group that comprises at least one nitrogen atom.

The nitrogen-containing monomer or at least one of the nitrogen-containing monomers of the monomer composition is preferably selected from the group consisting of nitrogen-containing (meth)acrylate monomers, vinylpyridine, 4-vinylpyridine, N-vinylphthalimide, N-vinyllactam, N-vinylpyrrolidone and N-vinylformamide.

Preference is given to nitrogen-containing (meth)acrylate monomers. The nitrogen-containing monomer or at least one of the nitrogen-containing monomers of the monomer composition is thus preferably a nitrogen-containing (meth)acrylate monomer.

A “nitrogen-containing (meth)acrylate monomer” is understood here to be a chemical compound which bears at least one methacrylate function or at least one acrylate function and additionally a functional group that comprises at least one nitrogen atom.

According to preferred embodiments of the invention, the nitrogen-containing (meth)acrylate monomer or at least one of the nitrogen-containing (meth)acrylate monomers of the monomer composition is selected from the group consisting of (meth)acrylamides, substituted (meth)acrylamides, amino (meth)acrylates, substituted amino(meth)acrylates, (meth)acrylonitrile, cyanoalkyl (meth)acrylates, and 4-(meth)acryloyloxymorpholine.

According to preferred embodiments of the invention, the nitrogen-containing (meth)acrylate monomer or at least one of the nitrogen-containing (meth)acrylate monomers of the monomer composition is selected from the group consisting of cyanoethyl acrylate, cyanoethyl methacrylate, diethylaminoethyl acrylate, diethylaminoethyl methacrylate, dimethylaminoethyl acrylate, dimethylaminoethyl methacrylate, dimethylaminopropylacrylamide, dimethylaminopropylmethacrylamide, N-(1-methylundecyl) acrylamide,
N-(n-butoxymethyl) acrylamide, N-(butoxymethyl) methacrylamide, N-(ethoxymethyl) acrylamide,
N-(n-octadecyl) acrylamide; N,N-dialkyl-substituted amides, for example
N, N-dimethylacrylamide, N,N-dimethylmethacrylamide, N,N-diethylacrylamide and N,N-diethylmethacrylamide, N-benzylacrylamide,
N-isopropylacrylamide, N-tert-butylacrylamide, N-tert-octylacrylamide, N-methylolacrylamide,
N-methylolmethacrylamide, 4-(meth)acryloylmorpholine, acrylonitrile and methacrylonitrile.

According to particularly advantageous embodiments, the monomer composition contains more than 15% by weight of at least one acrylamide as nitrogen-containing (meth)acrylate monomer, the acrylamide preferably being selected from the group consisting of dimethylaminopropylacrylamide, dimethylaminopropylmethacrylamide, N-(1-methylundecyl) acrylamide, N-(n-butoxymethyl) acrylamide, N-(butoxymethyl) methacrylamide,
N-(ethoxymethyl) acrylamide,
N-(n-octadecyl) acrylamide, N, N-dialkyl-substituted amides, for example
N,N-dimethylacrylamide, N,N-dimethylmethacrylamide, N,N-diethylacrylamide and N,N-diethylmethacrylamide, N-benzylacrylamide,
N-isopropylacrylamide, N-tert-butylacrylamide, N-tert-octylacrylamide, N-methylolacrylamide, and N-methylolmethacrylamide.

Very particularly preferably, at least one substituted acrylamide is present as nitrogen (meth)acrylate monomer, this being selected from the group consisting of N,N-dimethylacrylamide (NNDMA) and N,N-diethylacrylamide (NNDEA).

According to particularly advantageous embodiments, the monomer composition contains more than 15% by weight of the nitrogen-containing (meth)acrylate monomer N,N-dimethylacrylamide.

According to particularly advantageous embodiments, the monomer composition contains more than 15% by weight of the nitrogen-containing (meth)acrylate monomer N,N-diethylacrylamide.

The amount of the nitrogen-containing monomer or of the nitrogen-containing monomers is preferably more than 15% by weight and up to 55% by weight, more preferably up to 50% by weight, based on the total weight of the monomer composition.

According to advantageous embodiments of the invention, the amount of nitrogen-containing (meth)acrylate monomers is more than 25% by weight and preferably up to 55% by weight, more preferably up to 50% by weight, based on the total weight of the monomer composition.

Surprisingly, this results in improved storage stability under hot and humid conditions.

According to further advantageous embodiments of the invention, the amount of nitrogen-containing (meth)acrylate monomers is more than 15% by weight and preferably up to 25% by weight.

According to preferred embodiments, the poly(meth)acrylate of the adhesive compound comprises, in addition to the nitrogen-containing monomer, further at least proportionally copolymerized functional monomers, more preferably monomers of at least one kind having at least one functional group selected from the group consisting of ester groups, carboxylic acid groups, sulfonic acid groups, phosphonic acid groups, hydroxyl groups, acid anhydride groups, alkylene oxide groups and epoxy groups.

Said functional groups, with the exception of epoxy groups, are reactive toward epoxy groups, thereby advantageously making the poly(meth)acrylate amenable to thermal crosslinking with introduced epoxides.

According to advantageous embodiments of the invention, the monomer composition contains 0% by weight of (meth)acrylic acid, i.e. 0% by weight of acrylic acid and 0% by weight of methacrylic acid. Surprisingly, this achieves high storage stability, especially under hot and humid conditions, and a particularly high peel adhesion after storage under hot and humid conditions. Preferably, the monomer composition contains more than 25% by weight, more preferably 25% to 35% by weight, of at least one acrylamide, more particularly N,N-dimethylacrylamide and/or N,N-diethylacrylamide, and 15 to 25% by weight of at least one hydroxyl-containing (meth)acrylate monomer, more particularly 4-hydroxybutyl acrylate (4-HBA).

According to further advantageous embodiments of the invention, the monomer composition contains up to 4% by weight, in particular 0.1% to 4% by weight, of (meth)acrylic acid.

According to advantageous embodiments of the invention, the monomer composition contains 5% to 35% by weight, preferably 8 to 35% by weight, of at least one hydroxyl-containing (meth)acrylate monomer.

The hydroxyl-containing (meth)acrylate monomer is preferably selected from the group consisting of 4-hydroxybutyl acrylate, 2-hydroxyethyl acrylate, 2-hydroxypropyl acrylate, 2-hydroxybutyl acrylate, 2-hydroxyethyl methacrylate, 2-hydroxypropyl methacrylate, 2-hydroxybutyl methacrylate, 2-hydroxyisopropyl acrylate.

The hydroxyl-containing (meth)acrylate monomer is more preferably selected from the group consisting of 4-hydroxybutyl acrylate, 2-hydroxyisopropyl acrylate and 2-hydroxyethyl acrylate.

The hydroxyl-containing (meth)acrylate monomer is very preferably 4-hydroxybutyl acrylate (4-HBA).

The monomer composition may optionally contain one or more alkylene oxide-containing (meth)acrylate monomers. According to advantageous embodiments, however, only on the condition that in this case none of the alkylene oxide-containing (meth)acrylate monomers has a molecular weight of more than 305 g/mol.

Preferred, therefore, is an adhesive compound of the invention containing at least one poly(meth)acrylate based on a monomer composition, wherein the monomer composition optionally contains one or more alkylene oxide-containing (meth)acrylate monomers, on the condition that in this case none of the alkylene oxide-containing (meth)acrylate monomers has a molecular weight of more than 305 g/mol.

In other words, the monomer composition of these preferred embodiments is free from alkylene oxide-containing (meth)acrylate monomers having a molecular weight of more than 305 g/mol.

In particular, according to the preferred embodiments, not only is the poly(meth)acrylate free of alkylene oxide-containing (meth)acrylate monomers having a molecular weight of more than 305 g/mol, but also the adhesive compound of the invention as such.

In particular, with an adhesive compound that meets these conditions, a greater reduction in peel adhesion is achieved than is known from the prior art.

According to advantageous embodiments of the invention, the monomer composition contains 5% to 80% by weight, more preferably 21% to 80% by weight, of at least one alkylene oxide-containing (meth)acrylate monomer with a molecular weight of up to 305 g/mol, which may comprise (meth)acrylates or di-(meth)acrylates.

Preferred here are ethylene oxide-containing and/or propylene oxide-containing (meth)acrylate monomers with a molecular weight of up to 305 g/mol.

The at least one alkylene oxide-containing (meth)acrylate monomer with a molecular weight of up to 305 g/mol is preferably selected from the group consisting of 2-ethylhexyldiglycol acrylate, ethyldiglycol acrylate, ethylene dimethacrylate, ethylene glycol diacrylate, tetra(ethylene glycol) diacrylate, poly(ethylene glycol) diacrylates, di(ethylene glycol) diacrylate, ethylene glycol methyl ether acrylate, ethylene glycol phenyl ether acrylate, ethylene glycol dicyclopentenyl ether acrylate.

The at least one alkylene oxide-containing (meth)acrylate monomer is more preferably selected from the group consisting of 2-ethylhexyldiglycol acrylate (M=272 g/mol) and ethyldiglycol acrylate (M=188 g/mol).

Herewith, the glass transition temperature of the poly(meth)acrylate can be advantageously adjusted, especially if at the same time an amount of more than 20% by weight of NNDMA is included in the monomer composition. Particularly preferred here is 2-ethylhexyldiglycol acrylate.

According to advantageous embodiments of the invention, the monomer composition contains 0.1% to 6% by weight of at least one carboxyalkyl (meth)acrylate, with carboxyethyl acrylate being particularly preferred.

Surprisingly, the adhesive compound of the invention after bonding can also be electrically redetached with carboxyethyl acrylate as copolymerized monomer in the poly(meth)acrylate.

Carboxyethyl acrylate (CEA) is available in particular under CAS No. 24615-84-7 and the trade name Miramer CEA, from Miwon.

According to particularly advantageous embodiments of the invention, the monomer composition contains 5% to 85% by weight of at least one (meth)acrylate monomer without further functional groups, which is selected from the group consisting of
n-butyl acrylate, n-butyl methacrylate,
n-pentyl acrylate, n-pentyl methacrylate, n-hexyl acrylate,
n-hexyl methacrylate, n-heptyl acrylate, n-octyl acrylate, n-octyl methacrylate,
n-nonyl acrylate, isobutyl acrylate, isooctyl acrylate, isooctyl methacrylate,
2-ethylhexyl acrylate, 2-ethylhexyl methacrylate, 2-propylheptyl acrylate and
2-propylheptyl methacrylate.

More preferably, the (meth)acrylate monomer without further functional groups is selected from the group consisting of n-butyl acrylate, n-hexyl acrylate, n-octyl acrylate, isooctyl acrylate, 2-ethylhexyl acrylate and 2-propylheptyl acrylate, with n-butyl acrylate and/or 2-ethylhexyl acrylate being very preferred.

The one or more poly(meth)acrylates are preferably produced by conventional radical polymerizations or controlled radical polymerizations. For the sake of simplicity, the plural expression “the poly(meth)acrylates” is used below. Of course, all observations also apply in the event that one poly(meth)acrylate is contained in the adhesive compound.

The poly(meth)acrylates can be produced by copolymerization of the monomers using customary polymerization initiators and optionally chain transfer agents, with polymerization at the usual temperatures in bulk, in emulsion, for example in water or liquid hydrocarbons, or in solution.

The poly(meth)acrylates are produced preferably by copolymerization of the monomers in solvents, more preferably in solvents having a boiling range of 50 to 150° C., in particular from 60 to 120° C., using from 0.01% to 5% by weight, in particular from 0.1% to 2% by weight, in each case based on the total weight of the monomers, of polymerization initiators.

In principle, all customary initiators are suitable. Examples of radical sources are peroxides, hydroperoxides, and azo compounds, for example dibenzoyl peroxide, cumene hydroperoxide, cyclohexanone peroxide, di-t-butyl peroxide, cyclohexylsulfonyl acetyl peroxide, diisopropyl percarbonate, t-butyl peroctoate, and benzopinacol. Preferred radical initiators are 2,2′-azobis(2-methylbutyronitrile) (Vazo® 67™ from DuPont) or 2,2′-azobis(2-methylpropionitrile) (2,2′-azobisisobutyronitrile; AIBN; Vazo® 64™ from DuPont).

Preferred solvents for the production of the poly(meth)acrylates are alcohols such as methanol, ethanol, n-propanol, isopropanol, n-butanol, and isobutanol, in particular isopropanol and/or isobutanol; hydrocarbons such as toluene and in particular petrols having a boiling range of from 60 to 120° C.; ketones, in particular acetone, methyl ethyl ketone, methyl isobutyl ketone; esters such as ethyl acetate, and mixtures of the abovementioned solvents. Particularly preferred solvents are mixtures containing isopropanol in amounts of from 2% to 15% by weight, in particular from 3% to 10% by weight, in each case based on the solvent mixture used.

The poly(meth)acrylates preferably have a K value of from 20 to 90, more preferably from 40 to 80, measured in toluene (1% solution, 21° C.). The Fikentscher K value is a measure of the molecular weight and viscosity of polymers.

The poly(meth)acrylates of the adhesive compound of the invention, more particularly pressure-sensitive adhesive compound, are preferably crosslinked with thermal crosslinkers by means of coupling reactions-particularly in the sense of addition or substitution reactions
of functional groups present therein. All thermal crosslinkers may be used that
both ensure a sufficiently long processing time so that no gelation occurs during the processing process, particularly the extrusion process,
and result in rapid post-crosslinking of the polymer to the desired degree of crosslinking at temperatures lower than the processing temperature, in particular at room temperature. For example, it is possible to use as crosslinker a combination of polymers and isocyanates containing carboxy, amino and/or hydroxy groups, in particular aliphatic or blocked isocyanates, for example trimerized isocyanates deactivated with amines. Suitable isocyanates are in particular trimerized derivatives of MDI [4,4-methylenedi (phenyl isocyanate)], HDI [hexamethylene diisocyanate, 1,6-hexylene diisocyanate], and IPDI [isophorone diisocyanate, 5-isocyanato-1-isocyanatomethyl-1,3,3-trimethylcyclohexane], for example the products Desmodur® N3600 and XP2410 (both from Bayer AG: aliphatic polyisocyanates, low-viscosity HDI trimers). Also suitable is the surface-deactivated dispersion of micronized, trimerized IPDI BUEJ 339®, now HF9® (Bayer AG).

Preference is also given to crosslinking via complexing agents, also referred to as chelates. A preferred complexing agent is for example aluminum acetylacetonate, which is obtainable for example under the trade name Catana™ CAA 2072 from Sachen.

The poly(meth)acrylates in the adhesive compound of the invention, more particularly pressure-sensitive adhesive compound, are crosslinked preferably using epoxide(s), or using one or more substances containing epoxy groups. The substances containing epoxy groups are, in particular, polyfunctional epoxides, i.e., ones having at least two epoxy groups; this accordingly results overall in an indirect coupling of the structural units of the poly(meth)acrylates that bear the functional groups. The substances containing epoxy groups may be either aromatic or aliphatic compounds.

Preferably, a complexing agent, such as the aluminum chelate aluminum acetylacetonate, is used in combination with an epoxide. A suitable epoxide is, for example, 1,3-bis(N,N-diglycidylaminomethyl)cyclohexane (CAS No. 65992-66-7), which is available under the name S610 from Nantong Synasia Co., Ltd.

Exceptionally suitable polyfunctional epoxides are oligomers of epichlorohydrin, epoxy ethers of polyhydric alcohols, in particular ethylene glycol, propylene glycol, and butylene glycol, polyglycols, thiodiglycols, glycerol, pentaerythritol, sorbitol, polyvinyl alcohol, polyallyl alcohol, and the like; epoxy ethers of polyhydric phenols, in particular resorcinol, hydroquinone, bis(4-hydroxyphenyl) methane, bis(4-hydroxy-3-methylphenyl) methane, bis(4-hydroxy-3,5-dibromophenyl) methane, bis(4-hydroxy-3,5-difluorophenyl) methane, 1,1-bis(4-hydroxyphenyl) ethane, 2,2-bis(4-hydroxyphenyl) propane, 2,2-bis(4-hydroxy-3-methylphenyl) propane, 2,2-bis(4-hydroxy-3-chlorophenyl) propane, 2,2-bis(4-hydroxy-3,5-dichlorophenyl) propane, 2,2-bis(4-hydroxy-3,5-dichlorophenyl) propane, bis(4-hydroxyphenyl)phenylmethane, bis(4-hydroxyphenyl)phenylmethane, bis(4-hydroxyphenyl)diphenylmethane, bis(4-hydroxyphenyl)-4′-methylphenylmethane, 1,1-bis(4-hydroxyphenyl)-2,2,2-trichloroethane, bis(4-hydroxyphenyl)-(4-chlorophenyl) methane, 1,1-bis(4-hydroxyphenyl)cyclohexane, bis(4-hydroxyphenyl)cyclohexylmethane, 4,4′-dihydroxydiphenyl, 2,2′-dihydroxydiphenyl, 4,4′-dihydroxydiphenylsulfone, and hydroxyethyl ethers thereof; phenol-formaldehyde condensation products such as phenol-alcohols and phenol-aldehyde resins; epoxides containing S and N, for example 1,3-bis(N,N-diglycidylaminomethyl)cyclohexane (CAS No. 65992-66-7), N,N-diglycidylaniline and/or N,N′-dimethyldiglycidyl-4,4-diaminodiphenylmethane; and epoxides prepared by standard methods from polyunsaturated carboxylic acids or monounsaturated carboxylic esters of unsaturated alcohols; glycidyl esters; polyglycidyl esters that can be obtained by polymerization or copolymerization of glycidyl esters of unsaturated acids or obtainable from other acidic compounds, for example from cyanuric acid, diglycidyl sulfide or cyclic trimethylene trisulfone or derivatives thereof.

Very suitable ethers are for example butane-1,4-diol diglycidyl ether, polyglycerol-3 glycidyl ether, cyclohexanedimethanol diglycidyl ether, glycerol triglycidyl ether, neopentyl glycol diglycidyl ether, pentaerythritol tetraglycidyl ether, hexane-1,6-diol diglycidyl ether, polypropylene glycol diglycidyl ether, trimethylolpropane triglycidyl ether, pentaerythritol tetraglycidyl ether, bisphenol A diglycidyl ether, and bisphenol F diglycidyl ether.

Other preferred epoxides are cycloaliphatic epoxides, such as 3,4-epoxycyclohexylmethyl 3,4-epoxycyclohexanecarboxylate, which is commercially available under the trade name Uvacure® 1500 from Syensqo.

Further preferred epoxides are epoxy-functional organoalkoxysilanes and in particular cycloaliphatic epoxysilanes selected from the group consisting of (3-glycidyloxypropyl) trimethoxysilane (CAS No. 2530-83-8, for example Dynasylan® GLYMO, Evonik), (3-glycidyloxypropyl)triethoxysilane (CAS No. 2602-34-8, for example Dynasylan® GLYEO, Evonik), (3-glycidyloxypropyl)methyldimethoxysilane (CAS No. 65799-47-5, for example Gelest Inc.), (3-glycidyloxypropyl)methyldiethoxysilane (CAS No. 2897-60-1, for example Gelest Inc.),
5,6-epoxyhexyltriethoxysilane (CAS No. 86138-01-4, for example Gelest Inc.),
2-(3,4-epoxycyclohexyl)ethyl] trimethoxysilane (CAS No. 3388-04-3, for example Sigma-Aldrich),
2-(3,4-epoxycyclohexyl)ethyl] triethoxysilane (CAS No. 10217-34-2, for example ABCR GmbH),
triethoxy[3-[(3-ethyl-3-oxetanyl) methoxy]propyl]silane (CAS No. 220520-33-2, for example Aron Oxetane OXT-610, Toagosei Co., Ltd.).

The one or more crosslinkers are preferably used at in total 0.1 to 5 parts by weight, in particular at 0.2 to 1 part by weight, based on 100 parts by weight of poly(meth)acrylate.

More preferably, the poly(meth)acrylates are crosslinked by means of a crosslinker-accelerator system (“crosslinking system”) so as to obtain better control over the working time, the crosslinking kinetics, and the degree of crosslinking. The crosslinker-accelerator system preferably comprises at least one epoxy-group-containing substance as crosslinker and at least one substance as accelerator that has an accelerator effect on crosslinking reactions using epoxy-group-containing compounds at a temperature below the melting temperature of the polymer to be crosslinked.

The epoxy-group-containing substance serving as crosslinker comprises preferably and in particular the abovementioned epoxy-group-containing substances, to which all the above statements apply.

Particular preference in accordance with the invention is given to using amines as accelerators. These are to be formally understood as substitution products of ammonia; in the following formulas, the substituents are represented by “R” and encompass in particular alkyl and/or aryl radicals. Particular preference is given to those amines that do not react with the polymers to be crosslinked or react only negligibly.

In principle, primary (NRH₂), secondary (NR₂H), and tertiary amines (NR₃) can all be chosen as accelerators, including of course ones having a plurality of primary and/or secondary and/or tertiary amino groups. Particularly preferred accelerators are tertiary amines such as triethylamine, triethylenediamine, benzyldimethylamine, dimethylaminomethylphenol, 2,4,6-tris(N, N-dimethylaminomethyl) phenol, and N,N′-bis(3-(dimethylamino) propyl) urea. Other preferred accelerators are polyfunctional amines such as diamines, triamines, and/or tetramines, for example diethylenetriamine, triethylenetetramine, and trimethylhexamethylenediamine.

Other preferred accelerators are organosilanes containing at least one amino group and at least one alkoxy or acyloxy group. These allow the product properties to be refined still further. In particular and preferably, the accelerator here is at least one corresponding organosilane selected from the group consisting of
N-cyclohexyl-3-aminopropyltrimethoxysilane (CAS No. 3068-78-8),
N-cyclohexylaminomethyltriethoxysilane (CAS No. 26495-91-0),
3-aminopropyltrimethoxysilane (CAS No. 13822-56-5),
3-aminopropyltriethoxysilane (CAS No. 919-30-2),
3-aminopropylmethyldiethoxysilane (CAS No. 3179-76-8),
3-(2-aminomethylamino) propyltriethoxysilane (CAS No. 5089-72-5),
3-(N, N-dimethylaminopropyl) trimethoxysilane (CAS No. 2530-86-1), and
bis(2-hydroxyethyl)-3-aminopropyltriethoxysilane (CAS No. 7538-44-5).

Particularly preferred are 3-aminopropyltriethoxysilane (CAS No. 919-30-2) and/or
3-aminopropylmethyldiethoxysilane (CAS No. 3179-76-8).

Other preferred accelerators are aminoalcohols, in particular secondary and/or tertiary aminoalcohols; where there is more than one amino functionality per molecule, it is preferable that at least one, more preferably all, amino functionalities are secondary and/or tertiary. Particularly preferred as accelerators of this kind are triethanolamine, N,N-bis(2-hydroxypropyl) ethanolamine, N-methyldiethanolamine, N-ethyldiethanolamine, 2-aminocyclohexanol, bis(2-hydroxycyclohexyl)methylamine, 2-(diisopropylamino) ethanol, 2-(dibutylamino) ethanol, N-butyldiethanolamine, N-butylethanolamine, 2-[bis(2-hydroxyethyl)amino]-2-(hydroxymethyl)-propane-1,3-diol, 1-[bis(2-hydroxyethyl)amino]-2-propanol, triisopropanolamine, 2-(dimethylamino) ethanol, 2-(diethylamino) ethanol, 2-(2-dimethylaminoethoxy) ethanol, N,N,N′-trimethyl-N′-hydroxyethylbisaminoethyl ether, N,N,N′-trimethylaminoethylethanolamine, and N, N,N′-trimethylaminopropylethanolamine. Other suitable accelerators are pyridine, imidazoles, for example 2-methylimidazole, and 1,8-diazabicyclo[5.4.0]undec-7-ene. It is also possible to use cycloaliphatic polyamines as accelerators. Also suitable are phosphorus-based accelerators such as phosphines and/or phosphonium compounds, for example triphenylphosphine or tetraphenylphosphonium tetraphenylborate.

It is also possible to use quaternary ammonium compounds as accelerators; examples are tetrabutylammonium hydroxide, cetyltrimethylammonium bromide, and benzalkonium chloride.

Preferably, such accelerators are used at 0.1 to 5 parts by weight, in particular at 0.2 to 1 part by weight, based on 100 parts by weight of poly(meth)acrylate.

For setting further properties, the adhesive compound of the invention contains further additives according to advantageous embodiments.

Preferably, however, the proportion thereof is not more than 40 parts by weight based on 100 parts by weight of poly(meth)acrylate, preferably not more than 32 parts by weight. According to preferred embodiments, the adhesive compound of the invention comprises at least one elastomer, which is different from the poly(meth)acrylate preferably included. Preferred elastomers include, among others, those based on pure hydrocarbons, for example unsaturated polydienes such as natural or synthetically produced polyisoprene or polybutadiene, chemically substantially saturated elastomers, for example saturated ethylene-propylene copolymers, olefin copolymers, polyisobutylene, butyl rubber, ethylene-propylene rubber, vinylaromatic block copolymers, and chemically functionalized hydrocarbons, for example halogen-, acrylate-, allyl or vinyl ether-containing polyolefins, preferably with a fraction of 0.2 to 20 parts by weight based on 100 parts by weight of poly(meth)acrylate.

According to preferred embodiments of the invention, protective agents, and particularly corrosion inhibitors, are included as additives. These include primary and secondary antioxidants, light stabilizers and UV protectants, and flame retardants.

In addition, however, the adhesive compound may also contain dyes and pigments. The adhesive compound layer may accordingly be colored any desired color or may be white, gray, or black. Further additives of this kind, or others, that can typically be utilized are:
corrosion inhibitors, such as
   primary antioxidants, such as sterically hindered phenols, such as pentaerythritol tetrakis(3-(3,5-di-tert-butyl-4-hydroxyphenyl) propionate, preferably with a proportion of 0.2 to 1 part by weight based on 100 parts by weight of poly(meth)acrylate,
   secondary antioxidants, for example phosphites or thioethers, preferably with a proportion of 0.2 to 1 part by weight based on 100 parts by weight of poly(meth)acrylate,
process stabilizers, for example C radical scavengers, preferably with a proportion of 0.2 to 1 part by weight based on 100 parts by weight of poly(meth)acrylate,
light stabilizers, for example UV absorbers or sterically hindered amines, preferably with a proportion of 0.2 to 1 part by weight based on 100 parts by weight of poly(meth)acrylate,
processing aids, preferably with a proportion of 0.2 to 1 part by weight based on 100 parts by weight of poly(meth)acrylate.

According to preferred embodiments, the adhesive compound comprises at least one corrosion inhibitor selected from the group consisting of primary and secondary antioxidants. According to further preferred embodiments, however, the adhesive compound contains no corrosion inhibitor. Surprisingly, it has emerged that the use of such protective agents can be dispensed with when the invention's combination of the ionic liquids a) and b) is used.

According to preferred embodiments, the adhesive compound of the invention comprises at least one compatibilizer selected, for example, from the group consisting of polyethers, polyamines, polyvinylpyrrolidones or aliphatic polyesters. In addition, amphoteric substances such as alkali metal or alkaline earth fat soaps or anionic, cationic or nonionic surfactants are advantageously employable.

According to particularly preferred embodiments, the adhesive compound of the invention comprises as compatibilizer at least one polyether, preferably at least one substance selected from the group consisting of polyethylene glycol (PEG), polypropylene glycol (PPG), polytetrahydrofuran, with particular preference given to PEG and PPG. Here, a mixture of PEG and PPG is also conceivable and preferred. Block copolymers of PEG and PPG are likewise conceivable, as are polyethers bearing hydrocarbon segments.

The recited substances surprisingly achieve particularly good redetachability. Without wishing to be bound to a particular theory, it is conceivable that the ion flow of the electrolyte(s) through the layer of the compound is accelerated by the recited substances, in particular and for example PEG and/or PPG.

The total amount of compatibilizers in the adhesive compound, according to preferred embodiments in which at least one compatibilizer is present, is 0.1 to 10 parts by weight, preferably 1 to 5 parts by weight, based on 100 parts by weight of the polymers, and particularly poly(meth)acrylates, that are present.

This further optimizes the adhesive compound in respect of the conflicting aims regarding strength of adhesion and electrical redetachability.

In addition to the stated ionic liquids a) and b), the adhesive compound of the invention contains, in particular and preferably, no additive which significantly influences the pH value and thus cannot change the pH value at all or can change it by less than 0.1 pH, or only those substances whose pH values balance each other out and thus whose pure mixture results in a pH value of pH=6.9 to 7.1, in particular a pH value of 7. Any traces of monomers, such as acrylic acid, and/or initiators for the preparation of the polymers contained are present in particular only in traces, such as at a maximum of 0.2% by weight, preferably a maximum of 0.1% by weight, in particular less than 0.1% by weight, in the adhesive compound. The stated figures for amounts are based on the total weight of the adhesive compound. The stated amounts are not detrimental to the achievement of the technical effect. In the examples of the invention and the respective comparative examples given below, the same polymers with where relevant the same traces of monomers and initiators were used, so that the comparison highlights any possible influence of these traces which may be present.

Thus, in addition to the ionic liquids a) and b) stated above, the adhesive compound of the invention contains in particular and preferably also no additive which forms acids and/or bases in the adhesive compound of the invention or causes the formation thereof from the rest of the constituents.

According to particularly preferred embodiments of the invention, the adhesive compound of the invention comprises 100 parts by weight of at least one poly(meth)acrylate, wherein the poly(meth)acrylate is prepared by polymerization of a monomer composition which contains 16% to 20% by weight of N,N-dimethylacrylamide (NNDMA), 1% to 3% by weight of acrylic acid, 45% to 55% by weight of n-butyl acrylate and 25% to 35% by weight of 2-ethylhexyl acrylate, and 2 to 10 parts by weight of a mixture of the ionic liquids 1-butyl-3-methylimidazolium hexafluorophosphate and 1-ethyl-3-methylimidazolium dicyanamide, wherein the pH of the pure mixture of these ionic liquids is 7.3 to 8.2, preferably 7.5 to 8.

According to particularly preferred embodiments of the invention, the adhesive compound of the invention comprises 100 parts by weight of at least one poly(meth)acrylate, wherein the poly(meth)acrylate is prepared by polymerization of a monomer composition which contains 26% to 36% by weight of N, N-dimethylacrylamide (NNDMA), 15% to 30% by weight of 4-HBA, 25% to 40% by weight of n-butyl acrylate and 10% to 20% by weight of 2-ethylhexyl acrylate, and 2 to 10 parts by weight of a mixture of the ionic liquids 1-butyl-3-methylimidazolium hexafluorophosphate and 1-ethyl-3-methylimidazolium dicyanamide, wherein the pH of the pure mixture of these ionic liquids is 7.3 to 8.2, preferably 7.5 to 8.

Preferably, in all embodiments, the amounts of the monomers each specifically listed in the respective monomer compositions respectively make up 100% by weight.

The adhesive compound of the invention is preferably a pressure-sensitive adhesive compound.

A pressure-sensitive adhesive compound is in the present case understood as meaning, as is generally usual, a substance that-particularly at room temperature—is durably tacky and adhesive. Characteristic of a pressure-sensitive adhesive compound is that it can be applied by pressure to a substrate and remains stuck there, the pressure to be applied and the duration of exposure to this pressure not being defined in more detail. In some cases, depending on the exact nature of the pressure-sensitive adhesive compound, the temperature, and the humidity, and on the substrate, the effect of a short-lived, minimal pressure that does not go beyond light contact for a brief moment is sufficient to achieve the adhesion effect; in other cases a more lengthy exposure to a high pressure may also be necessary.

Pressure-sensitive adhesive compounds have particular, characteristic viscoelastic properties that result in durable stickiness and adhesive capability. It is a characteristic feature thereof that, when they are mechanically deformed, the result is both viscous flow processes and the development of elastic resilience forces. The two processes are in a certain relation with one another that depends not just on the exact composition, the structure, and the degree of crosslinking of the pressure-sensitive adhesive compound, but also on the rapidity and duration of the deformation and on the temperature.

The viscous flow component is necessary for achievement of adhesion. Only the viscous components, brought about by macromolecules having relatively high mobility, allow good wetting and good flow onto the substrate to be bonded. A high proportion of viscous flow leads to high pressure-sensitive adhesiveness (also referred to as tack or surface stickiness) and hence often also to a high strength of adhesion. Highly crosslinked systems, or polymers that are crystalline or solidify in vitreous form, generally have at least only low pressure-sensitive adhesion, if any, for lack of free-flowing components.

The elastic resilience force components are needed for achievement of cohesion. They are brought about, for example, by very long-chain and entangled macromolecules that are crosslinked physically or chemically, and enable transmission of the forces that attack an adhesive bond. They have the effect that an adhesive bond can withstand a sustained stress acting thereon, for example in the form of a sustained shear stress, to a sufficient degree over a prolonged period of time.

For the more precise description and quantification of the extent of elastic and viscous components and of the relation of the components to one another, the variables of storage modulus (G′) and loss modulus (G⁻), which can be determined by means of dynamic mechanical analysis (DMA, according to DIN EN ISO 6721-1:2019), can be employed. G′ is a measure of the elastic component and G″ a measure of the viscous component of a substance. Both parameters are dependent on deformation frequency and temperature.

The parameters can be determined with the aid of a rheometer. The material under examination is subjected here to a sinusoidally oscillating shear stress, for example in a plate-plate arrangement. In the case of shear stress-controlled devices, deformation as a function of time and the time delay of this deformation are measured with respect to the onset of shear stress. This time delay is referred to as the phase angle θ.

The storage modulus G′ is defined as follows:

$${G}^{′} = ( ⊤ / γ ) \cdot cos ( δ ) ( ⊤ = shear stress , γ = deformation , δ = phase angle = phase shift between shear stress vector and deformation vector ) .$$

The definition of the loss modulus G″ is:

$${G}^{″} = ( ⊤ / γ ) \cdot cos ( δ ) ( ⊤ = shear stress , γ = deformation , δ = phase angle = phase shift between shear stress vector and deformation vector ) .$$

A substance is generally considered to be pressure-sensitive adhesive and is defined as pressure-sensitive adhesive for the purposes of the invention if at room temperature, here by definition at 23° C., in the deformation frequency range from 10° to 101 rad/see, G′ is at least partly in the range from 103 to 107 Pa and if G″ is also at least partly in this range. “Partly” means that at least one portion of the G′ curve is within the window spanned by the deformation frequency range from inclusively 10° to inclusively 101 rad/see (abscissa) and the range of the G′ values from inclusively 103 to inclusively 107 Pa (ordinate). For G″, this applies mutatis mutandis.

Preferably, the pressure-sensitive adhesive compound in the deformation frequency range from 10° to 101 rad/see at 23° C. has a storage modulus G′ and a loss modulus G″ in the range from 103 to 107 Pa, determined according to DIN EN ISO 6721-1:2019.

To achieve the viscoelastic properties, the monomers on which the polymers underlying the pressure-sensitive adhesive compound are based and any further components present in the pressure-sensitive adhesive compound are chosen in particular such that the pressure-sensitive adhesive compound has a glass transition temperature (according to DIN 53765:1994-03) below the use temperature (i.e., typically below room temperature (23° C.)). By means of suitable cohesion-enhancing measures, for example crosslinking reactions (formation of bridging linkages between the macromolecules), it is possible to enlarge and/or to shift the temperature range in which a polymer composition has pressure-sensitive adhesive properties. The range of application of the pressure-sensitive adhesive compounds can thus be optimized via a setting between flowability and cohesion of the composition.

In particular, the pressure-sensitive adhesive compound has a glass transition temperature of ≤23° C., determined in accordance with DIN 53765:1994-03.

In contrast to pressure-sensitive adhesives, hot-melt adhesives, for example ones based on polyamides, polyurethanes or modified polyethylene, typically display no stickiness at room temperature (23° C.), even though present in hot-melt adhesive compounds.

The present invention also provides an adhesive tape comprising at least one adhesive compound layer D of at least one adhesive compound of the invention.

The adhesive tape of the invention is preferably a double-sided adhesive tape. For the sake of simplicity, the adhesive tape of the invention is referred to in the context of the present invention as “adhesive tape” in the double-sided embodiments too.

The present invention relates to an adhesive tape, which may be present in any desired finished form but with preference given to rolls of adhesive tape. The adhesive tape, particularly in elongate sheet form, can be produced either in the form of a roll, i.e. rolled up on itself in the form of an Archimedean spiral, or as adhesive strips, as obtained for example in the form of blanks or die cuts.

The adhesive tape of the invention is in particular present in elongate sheet form. An elongate sheet is understood as meaning an object, the length of which (extent in the x direction) is many times greater than its width (extent in the y direction), the width remaining approximately and preferably exactly the same over the entire length.

The general expression “adhesive tape”, or else synonymously “adhesive strip”, for the purposes of the present invention encompasses all sheetlike structures, such as films or film sections extending in two dimensions, tapes having extended length and limited width, sections of tape and the like, and lastly also diecuts or labels.

In addition to the longitudinal extent (x direction) and lateral extent (y direction), the adhesive tape also has a thickness (z direction) running perpendicular to the two extents, the lateral extent and longitudinal extent being many times greater than the thickness. The thickness is very substantially the same, preferably exactly the same within tolerances, over the entire areal extent of the adhesive tapes determined by their length and width.

The statements apply by analogy to the carrier layer(s) that form(s) a layer in the x and y direction as an element of the adhesive tape according to some preferred embodiments.

It is understood that the individual layers are arranged on top of one another along the z direction.

The present invention also provides a bonded composite comprising at least the following layers:
a first substrate A; and
a second substrate B; and
an adhesive tape of the invention that is arranged between the substrate A and the substrate B and bonds the substrates A and B together.

In particular, either the substrate A and the substrate B or at least one of the substrates and the adhesive tape, at not less than one point, or none of the substrates and the adhesive tape, at two different points, are designed to be electrically conductive.

The present invention also provides a method for electrically debonding the assembly of the invention, comprising at least the following method steps:
i.) applying a voltage at two different electrically conductive points of the assembly, the voltage being preferably from 1 to 50 V.

The voltage is applied according to step i.) of the method of the invention for electrically debonding the composite.

The voltage is in particular a DC voltage.

The voltage is preferably from 2 to 50 V.

According to preferred embodiments of the invention, the voltage is from 3 to 12 V. Such a voltage can in particular be applied by means of a battery located in the immediate vicinity of the bond, such as, in particular and for example, in a cell phone, tablet, etc., or by adding a battery from outside.

According to further preferred embodiments of the invention, the voltage is from 12 to 50 V. This relatively high voltage allows redetachment to take place particularly swiftly; the voltage for this need only be applied for a few seconds.

Depending on the chosen voltage in particular, the duration of application of the voltage in step i.) can be from a few seconds, more particularly 2 seconds, up to 900 seconds, preferably up to 600 seconds.

It is of course also conceivable for the voltage to be applied for a period of time longer than 900 seconds, particularly if the voltage is relatively low.

The method of the invention for electrically debonding the composite of the invention allows the substrates A and B to be debonded from one another in a swift and easy manner without too much force being required.

If the layers do not separate from one another without further action after applying the voltage, the method of the invention comprises at least the following further method step:
ii.) applying force to the adhesive compound layer D and/or to substrate A and/or to substrate B, such that the distance between substrates A and B is increased.

The force that may still be required according to step ii) is significantly lower than the strength of adhesion prior to applying the voltage according to step i.)

The application of the voltage according to step i.) takes place at two different points on the bonded composite of the invention. The points at which the voltage is advantageously applied depend on the construction of the adhesive tape and of the bonded composite and thus on the nature of the individual layers and substrates A and B bonded together.

Some preferred embodiments are set out hereinbelow.

According to preferred embodiments, the adhesive tape is an adhesive transfer tape and consists of the adhesive compound layer D.

In a bonded assembly comprising two substrates A and B, such an adhesive tape can advantageously be electrically debonded again by virtue of the fact that both substrates A and B are electrically conductive. For this purpose, a voltage is then applied to the substrates A and B, so that the peel adhesion decreases. Without wishing to be bound to a particular theory, the inventors assume the following mechanism: Applying voltage results in a migration of the ions of the ionic liquids, more particularly a separation of the anions and cations of the ionic liquids, in the adhesive compound layer D. This results in the adhesion of the adhesive compound layer D to the substrate A and/or to the substrate B being greatly reduced and in the debonding of these layers from one another. In particular, the adhesive cleavage takes place with respect to the substrate to which the negative pole has been applied.

According to preferred embodiments of the present invention, the bonded assembly thus comprises the following layers:
a first substrate A that is electrically conductive; and
a second substrate B that is electrically conductive; and
an adhesive tape of the invention that consists of the adhesive compound layer D and is arranged between the substrate A and the substrate B and bonds the substrates A and B together.

According to further preferred embodiments, the adhesive tape comprises in addition to the first adhesive compound layer D at least the following layers:
a second adhesive compound layer C; and at least one electrically conductive carrier layer T that is arranged between layers D and C.

An adhesive tape of this kind can as a double-sided adhesive tape be adapted to a variety of different substrates via the second adhesive compound layer C. These can in principle be the same substrates as those in the above embodiments in which the adhesive tape is an adhesive transfer tape.

However, an adhesive tape of this kind can in particular and advantageously also be used in order to later debond substrates A and B from one another when only one is electrically conductive, for example substrate A.

According to preferred embodiments, either xi.) only the carrier layer T or xii.) the carrier layer T and the second adhesive compound layer C are designed to be electrically conductive.

This means that a voltage can be applied to xi.) the electrically conductive carrier layer or xii.) to the second adhesive compound layer C and to the conductive substrate A.

The adhesive tape is initially advantageously bonded as a double-sided adhesive tape such that the electrically debondable adhesive compound layer D is attached to the conductive substrate A and the second adhesive compound layer to the substrate B, which can be conductive, but does not need to be.

According to preferred embodiments of the invention, xi.) only the carrier layer is electrically conductive. A voltage can in particular and preferably be applied particularly readily thereto when the carrier layer protrudes laterally over at least one of the adhesive compound layers. According to further preferred embodiments of the invention, xii.) the carrier layer and the second adhesive compound layer C are electrically conductive. A construction of this kind has the advantage that the voltage can be applied to the adhesive compound layer C. A lateral overhang of the carrier layer is not necessary. The adhesive tape can therefore be produced in a simple manner, particularly since layers D, T and C can be die-cut together.

Preferably, the adhesive tape according to the embodiments described above consists of the three layers D, T, and C. This is also referred to in the context of the present invention as a three-layer composite D-T-C.

According to preferred embodiments of the present invention, the bonded assembly thus comprises the following layers:
a first substrate A that is electrically conductive; and
a second substrate B; and
an adhesive tape of the invention that consists of the three-layer composite D-T-C and bonds the substrates A and B together such that the adhesive compound layer D is attached to the conductive substrate A.

If, in the method for electrically debonding these preceding embodiments, the negative pole is applied to the conductive substrate A and the positive pole to the carrier layer T or the second adhesive compound layer C, then adhesive cleavage takes place in particular between the conductive substrate A and the adhesive compound layer D.

According to further preferred embodiments, the adhesive tape comprises in addition to the first adhesive compound layer D at least the following layers:
a second adhesive compound layer C; and
at least one first electrically conductive carrier layer T that is arranged between the layers D and C; and
at least one second electrically conductive carrier layer T′ that is arranged on the surface of the adhesive compound layer D on the opposite side to the first electrically conductive carrier layer T; and
a third adhesive compound layer C′ that is arranged on the surface of the second electrically conductive carrier layer T′ on the opposite side to the first adhesive compound layer D.

An adhesive tape of this kind has at least the layer construction C-T-D-T′-C′ and, as a double-sided adhesive tape, can be adapted to a variety of different substrates via the adhesive compound layers C and C′.

These can in principle be the same substrates as those in the above embodiments in which the adhesive tape is an adhesive transfer tape or has the three-layer construction D-T-C. However, an adhesive tape of this kind can in particular and advantageously be used in order to later debond substrates A and B from one another when neither is electrically conductive. According to preferred embodiments, either xi.) only the carrier layers T and T′ or xii.) the carrier layers T and T′ and the second adhesive compound layer C and/or the third adhesive compound layer C′ are designed to be electrically conductive.

This means that voltage can be applied to xi.) both electrically conductive carrier layers or xii.) to at least one of the adhesive compound layers C and C′ and to one of the carrier layers or to the other adhesive compound layer.

In analogy to above embodiments, it is assumed that applying the voltage results in migration of the ions, more particularly a separation of the anions and cations of the ionic liquids, in the adhesive compound layer D. This results in the adhesion of the adhesive compound layer D to the electrically conductive carrier layers T and/or T′ being greatly reduced and in the debonding of these layers from one another.

According to preferred embodiments of the invention, xi.) only the carrier layers T and T′ are electrically conductive. A voltage can in particular and preferably be applied particularly readily thereto when the carrier layers T and T′ protrude laterally over at least one of the respectively adjacent adhesive compound layers.

According to further preferred embodiments of the invention, xii.) the carrier layers T and T′ and the second and third adhesive compound layer C and C′ are electrically conductive. A construction of this kind has the advantage that the voltage can be applied to the adhesive compound layers C and C′. A lateral overhang of the carrier layers T and T′ is not necessary. The adhesive tape can therefore be produced in a simple manner, particularly since layers C, T, D, T′, and C can be die-cut together.

Preferably, the adhesive tape according to the embodiments described above consists of the five layers C, T, D, T′, and C′. This is also referred to in the context of the present invention as a five-layer composite C-T-D-T′-C′.

According to preferred embodiments of the present invention, the bonded assembly thus comprises the following layers:
a first substrate A; and
a second substrate B; and
an adhesive tape of the invention that consists of the five-layer composite C-T-D-T′-C′ and bonds the substrates A and B together.

The electrically conductive substrate in all embodiments may be for example a cell phone casing made of metal—for example, of aluminum or steel.

In all embodiments, the electrically non-conductive substrate may in particular be a casing made of a non-conductive material, such as plastic, or a battery or other non-electrically conductive components, for example speakers.

The present invention also provides for the use of the adhesive compound of the invention for the bonding of components in electronic devices, automobiles, medical devices, and dental devices.

The present invention also provides for the use of the adhesive tape of the invention for the bonding of components in electronic devices, automobiles, medical devices, and dental devices.

The carrier layers T or T and T′ in all the abovementioned embodiments are electrically conductive.

These layers are described hereinbelow. For the sake of simplicity, the term “electrically conductive carrier layer” or else just “carrier layer” is used. Depending on which one of the above embodiments, this refers to the carrier layer T or the carrier layers T and T′. The carrier layers T and T′ are independent of one another and can be identical or different from one another.

Preferably, the electrically conductive carrier layer comprises at least one metal.

According to preferred embodiments of the invention, the metal is selected from the group consisting of copper, nickel, zinc, tin, silver, gold, aluminum, iron, chromium, and alloys of said metals. Very preferably, the metal is selected from the group consisting of aluminum, tin, copper and nickel. Aluminum or tin are very preferred.

Preferably, the electrically conductive carrier layer has a layer thickness, measured in the z direction, i.e. parallel to the stacking direction of the layer arrangement, of from 10 nm (nanometers) to 50 μm (micrometers).

According to preferred embodiments of the invention, the electrically conductive carrier layer includes a) at least one metal foil, preferably an aluminum foil, and/or b) at least one electrically conductive textile including at least one metal, preferably selected from the group consisting of copper and nickel, and/or c) one or more plies of at least one metal deposited by vapor deposition, preferably selected from the group consisting of copper, tin and aluminum, and/or d) at least one metal grid and/or e) a foil coated with metal by vapor deposition.

In principle, it is also conceivable here for the layer T to include a combination of two or more of the above options.

Metal foils, for example and preferably aluminum foils, are known to those skilled in the art. The metal foil, for example and preferably the aluminum foil, preferably has a layer thickness, measured in the z direction, i.e. parallel to the stacking direction of the layer arrangement, of from 5 to 50 μm, more preferably from 10 to 30 μm.

Electrically conductive textiles are known to those skilled in the art, in particular under the expression “conductive mesh”. This is a textile fabric, for example one made of PET (polyethylene terephthalate), that is coated with a metal, for example with copper and/or nickel, this being how the electrical conductivity of the fabric is produced.

Those skilled in the art are likewise aware that metals can undergo direct vapor deposition as a monolayer or multilayer onto surfaces such as in this case the surface of an adhesive compound layer.

In the context of the present invention, the electrically conductive carrier layer can be provided by vapor deposition of metal onto the adhesive compound layer D or the adhesive compound layer C or the adhesive compound layer C′.

In addition, those skilled in the art are familiar with metal grids of varying dimensions. Metal grids having suitable layer thicknesses can be produced for example through a laid scrim of appropriately fine metal threads or by die-cutting at least one foil of appropriate layer thickness.

In the case of a film coated with metal by vapor deposition, a non-conductive film in particular is coated with metal by vapor deposition in order to make it electrically conductive. The metal is preferably selected from the group consisting of aluminum, nickel and tin, with tin or aluminum being particularly preferred. The film material can in principle be selected from all materials capable of undergoing vapor deposition with metal and of being used as a carrier film in adhesive tapes. The material is selected in particular from polyesters and polyolefins, a mixture of a more than one material also being conceivable. Particularly preferred polyesters are polyethylene terephthalate (PET) and polyethylene naphthalate (PEN). Particularly preferred polyolefins are polypropylene (PP) and polyethylene (PE). According to preferred embodiments, the film material is selected from the group consisting of PET, PEN, PE, and PP.

Preferably, it is a PET (polyethylene terephthalate) film. A film of this kind is dimensionally stable and therefore easy to process without significant stretching or tearing. This makes it possible to durably apply a homogeneous and gapless metal layer, with the result that the electrical conductivity, particularly in the z direction, is durably guaranteed across the entire film.

In the embodiments in which at least one electrically conductive carrier layer T or at least two electrically conductive carrier layers T and T′ are present, it is preferable that this at least one adjacent adhesive compound layer protrudes laterally in at least one direction of extension of the layer plane and thus includes a lateral overhang. A voltage can then be applied to this lateral overhang in a simple manner.

In the case of the five-layer composite, the lateral overhangs of the electrically conductive carrier layers T and T′ are in advantageous embodiments arranged spatially apart from one another. This makes it easier to apply a voltage to said two overhangs.

In the case of metal deposited by vapor deposition as a carrier layer, it is preferable that this carrier layer protrudes laterally in at least one direction of extension of the layer plane over just one adjacent adhesive compound layer, the respective other adhesive compound layer serving as a mechanical support for this metal layer. The metal layer in this case has no actual carrier function. Rather, the other adhesive compound layer serves as a carrier for the metal layer. For the sake of simplicity, the term carrier layer is however retained for the metal layer in these embodiments too. Preferably, the layer thickness of layer T is in this case greater than or equal to 10 nm (nanometers), preferably 50 to 200 nm.

According to preferred embodiments of the invention, the electrically conductive carrier layer T or T and/or T′ e) comprises a foil vapor-coated with metal, and protrudes beyond the first adhesive compound layer D and the second adhesive compound layer C or the first adhesive compound layer D and the second adhesive compound layer C and/or the first adhesive compound layer D and the third adhesive compound layer C′ in at least one extent direction. In this case, the film is coated with metal by vapor deposition, in particular on one surface, and the respective carrier layer is attached via the metalized surface to the first adhesive compound layer D, and thus to the electrically detachable layer.

This allows a voltage to be applied to the carrier layer in a simple and safe manner. At the same time, the adhesive tape can be produced in a relatively simple manner.

The expression “protrude laterally” is understood in the context of the present invention as meaning any kind of lateral overhang of the layer or layers concerned and means that the layer respectively concerned extends beyond the layer of reference, more particularly in the “xy” plane and thus laterally, i.e., perpendicular to the stacking direction. In the context of the present invention, the terms “lateral extension” or “section of lateral extension” are also used instead of the term “lateral overhang”.

The term “lateral” refers here to each direction of extent of the layer plane “xy” perpendicular to the stacking direction of the layers “z”. The term is thus in particular independent of the geometric shape of the adhesive tape in the “xy” plane, which can for example be a rectangle, as is customary for adhesive tapes (see above), but can also be a square or a circle.

The term does not address minor fluctuations in the dimensions of the individual layers in the “xy” plane that result from the die-cutting process or similar shaping processes, particularly since the dimensions of such minor material overhangs preclude the application of a voltage thereto in the planned manner.

The adhesive compound layers C or C and C′ can in principle be based on the same compounds as the adhesive compound layer D; the adhesive compounds of layers C or C and C′ do not have to contain any electrolytes, in particular any ionic liquids, but may do so. Preferably, the layers C or C and C′ do not contain any electrolytes, in particular any ionic liquids.

According to some embodiments of the three-layer composite D-T-C described above, the adhesive compound layer C is electrically conductive.

Likewise, the adhesive compound layer C and/or adhesive compound layer C′ of the five-layer composite C-T-D-T′-C′ can be designed to be electrically conductive.

These layers are described hereinbelow. For the sake of simplicity, the term “electrically conductive adhesive compound layer” is used at appropriate points. Depending on which one of the above embodiments, this refers to the adhesive compound layer C or adhesive compound layers C and/or C′. In addition, for the sake of simplicity, the expression “the adhesive compound layers C or C and/or C” is used, this meaning the respective layers in the described embodiments of the adhesive tape that include at least the three-layer composite or at least the five-layer composite.

The adhesive compound layers C and C′ are independent of one another and may be identical or different from one another.

Preferably, the electrically conductive adhesive compound layer comprises at least one metal for this purpose, such as in particular nickel, copper or silver, preferably in the form of electrically conductive metal particles and/or metallized particles, more preferably metal particles.

Metallized particles are in particular and preferably glass or polymer particles metallized with at least one metal, with the result that the previously electrically non-conductive particles are made electrically conductive by the metallization.

Particularly preferably, the electrically conductive adhesive compound layer comprises electrically conductive particles selected from the group consisting of nickel particles, copper particles, and silver-coated copper particles.

According to particularly preferred embodiments, the electrically conductive adhesive compound layer comprises nickel particles.

Preferably, the electrically conductive adhesive compound layer contains 5 to 40 parts by weight, more preferably 20 to 40 parts by weight, very preferably 25 to 35 parts by weight, of electrically conductive particles, more particularly metal particles and/or metallized particles, based on 100 parts by weight of polymers present.

The electrically conductive particles should preferably be not larger, or not significantly larger, than the respective thickness of the electrically conductive adhesive compound layer in the z direction, measured with a light microscope.

Preferably, the electrically conductive particles have an average particle size of from 1 to 10 μm, more preferably from 1 to 6 μm, even more preferably from 3 to 5 μm, such as in particular 4 μm.

The electrically conductive adhesive compound layer is in particular electrically conductive at least in the z direction.

However, it may also be electrically conductive in the xy plane. If the electrically conductive adhesive compound layer is designed to be electrically conductive only in the z direction, but not necessarily in the xy direction, a smaller amount of these materials is needed in preferred embodiments in which a metal, in particular metal particles, is added to achieve the electrical conductivity. This optimizes the adhesive compound with regard to the required conductivity, strength of adhesion, flow behavior, and also costs.

A layer is considered to be “electrically conductive” in the context of the present invention in particular when the resistance is less than 1 ohm, as measured in the respective direction, in this case more particularly in z direction, according to the standard MIL-DTL-83528C.

Irrespective of whether the adhesive compound layers C or C and C′ are designed to be electrically conductive, the statements below apply.

The adhesive compound in the adhesive compound layers C or C and C′ is according to preferred embodiments not a pressure-sensitive adhesive compound.

According to particularly preferred embodiments of the invention, the adhesive compound in the adhesive compound layers C or C and C′ is a pressure-sensitive adhesive compound and the adhesive compound layer C or C and C′ is thus a layer of pressure-sensitive adhesive compound.

The adhesive compound layers C or C and/or C′ according to preferred embodiments of the invention have the same composition as the adhesive compound layer D.

According to further preferred embodiments of the invention, the adhesive compound used in the adhesive compound layers C or C and/or C′ is a different adhesive compound to the one used in the adhesive compound layer D.

This makes it possible to adapt the properties of the conductive layer particularly well to the substrate(s) bonded via the adhesive compound layer C or C and/or C′. Since the adhesive compound layer C or C and/or C′ preferably does not contain, or have to contain, any electrolytes, in particular any ionic liquid, the constituents do not have to be adapted thereto.

According to preferred embodiments of the invention, the adhesive compound used in the adhesive compound layers C or C and/or C′ is a different adhesive compound to the one used in the adhesive compound layer D; the adhesive compound in the adhesive compound layers C or C and/or C′ may be heat-activatable or may be a different acrylate-based pressure-sensitive adhesive compound.

The adhesive compound in the adhesive compound layer D and—depending on the embodiment-further adhesive compounds are produced by known processes and brought into layer form, in particular by coating. This can be done by using one or more suitable solvents or else without use of solvents.

In addition, one or more drying steps may optionally be performed.

According to preferred embodiments, the poly(meth)acrylate is polymerized in solvents or solvent-free and then the further substances, in particular the mixture of the ionic liquids a) and b), crosslinkers and optionally further additives, are added, and the compound is optionally adjusted by means of solvents to a desired solids content.

The compound is then conventionally coated, in particular onto a liner or a carrier layer, and dried.

According to further preferred embodiments, the adhesive compounds of the invention are produced without solvents by extrusion, which is a further advantage of the present invention. This means that, even during production of the adhesive compounds and adhesive compound layers of the invention, it is possible—in addition to the later possibility of redetachment—to further boost the degree of sustainability by avoiding the use of solvents.

The lamination of a plurality of layers on top of one another is effected in a manner known to those skilled in the art, the layers being superposed such that this affords in particular a layer composite DTC, where T is arranged between D and C, or C′-T′-D-T-C as a double-sided adhesive tape.

The carrier layers T and T′ can be provided in various ways as already described above.

Thus, it is conceivable that a) a metal foil, in particular an aluminum foil, and/or b) an electrically conductive mesh and/or d) at least one metal grid and/or e) a PET film coated with metal by vapor deposition is positioned between the respective adhesive compound layers.

In addition, it is possible for c) metal particles to undergo direct vapor deposition onto the surface of the adhesive compound layer D or C or C′.

The adhesive tape of the invention is in particular a double-sided adhesive tape in which, depending on the embodiment, two surfaces of the adhesive compound layer D (adhesive transfer tape) or a surface of the first adhesive compound layer D and a surface of the second adhesive compound layer C (three-layer composite D-T-C) or one surface each of the adhesive compound layers C and C′ (five-layer composite C-T-D-T′-C′) are available for bonding to substrates.

Advantageously, the outer, exposed surfaces of the adhesive compound layers of the adhesive tape of the invention can be provided with anti-adhesive materials, such as a release paper or a release film, also termed a liner. A liner may also be a material having anti-adhesive coating on at least one side, preferably on both sides, for example double-sidedly siliconized material. A liner, or in more general terms a temporary carrier, is not part of an adhesive tape, but merely an auxiliary for the production and/or storage thereof and/or for further processing by die-cutting. Furthermore, a liner, as opposed to a permanent carrier, is not firmly bonded to an adhesive layer but instead functions as a temporary carrier, i.e. as a carrier that can be peeled away from the adhesive layer. “Permanent carriers” are also referred to synonymously simply as “carriers” in the present application.

The thickness of the individual adhesive compound layer(s) (in the z direction) is preferably from 15 to 2000 μm, particularly preferably from 20 to 500 μm, very particularly preferably from to 200 μm. However, the thickness is preferably as small as possible, for example 100 μm or less.

In the embodiments of the three-layer composite D-T-C and the five-layer composite C-T-D-T′-C′, the adhesive compound layers D and C and D and C′ have different layer thicknesses in preferred embodiments, the thickness of the adhesive compound layer D being for example less than that of the adhesive compound layers C and C′.

In further preferred embodiments, the layers D and C or D, C, and C′ have the same layer thickness.

If the layer thickness of the layer D is too high, it may become uneconomically costly on account of the ionic liquids present therein.

To boost the anchoring of the adhesive compound layer(s) on a carrier layer, if desired, the carrier layer can be chemically and/or physically pretreated, in particular physically pretreated. Corona, plasma or flame pretreatment is conceivable. Corona surface treatment is also known for metalized films to those skilled in the art and is described for example in EP 0355622 A2.

In the following, preferred embodiments of the invention are elucidated and described more particularly with reference to the accompanying figures. In these figures,

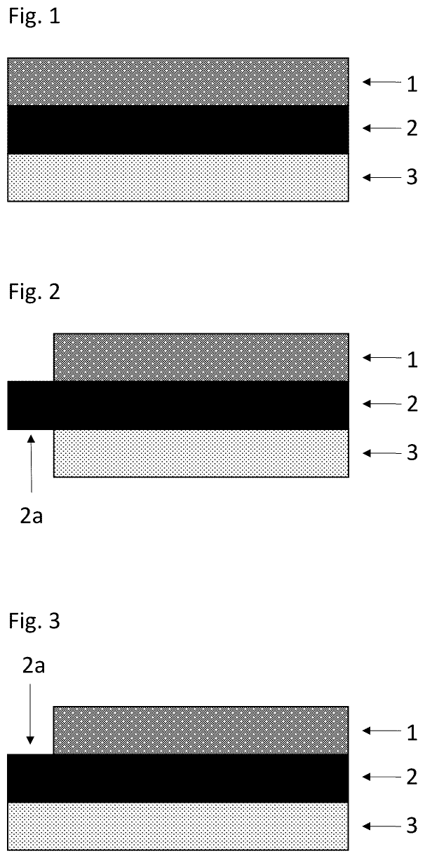

FIG. 1 shows a simplified schematic cross-sectional representation through a double-sided adhesive tape of the invention in a preferred embodiment; and

FIG. 2 shows a simplified schematic cross-sectional representation through a double-sided adhesive tape of the invention in a preferred embodiment; and

FIG. 3 shows a simplified schematic cross-sectional representation through a double-sided adhesive tape of the invention in a preferred embodiment; and

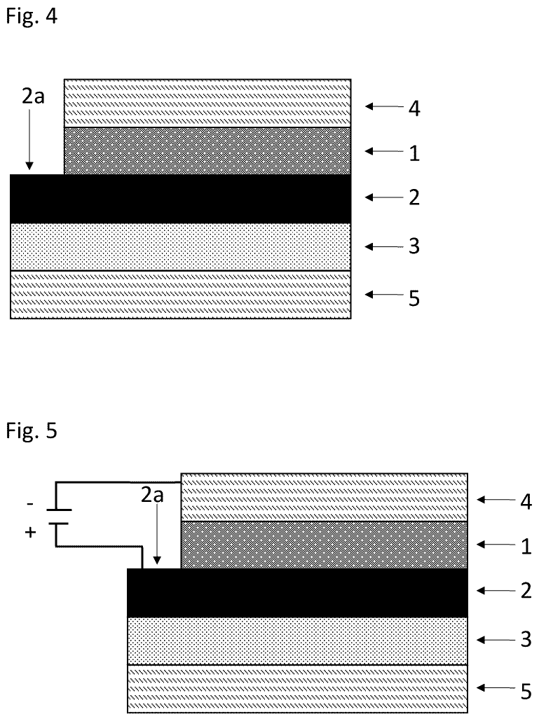

FIG. 4 shows a simplified schematic cross-sectional representation through a bonded composite of the invention in a preferred embodiment; and

FIG. 5 shows a simplified schematic cross-sectional representation through a bonded composite of the invention to which a voltage is being applied, in a preferred embodiment; and

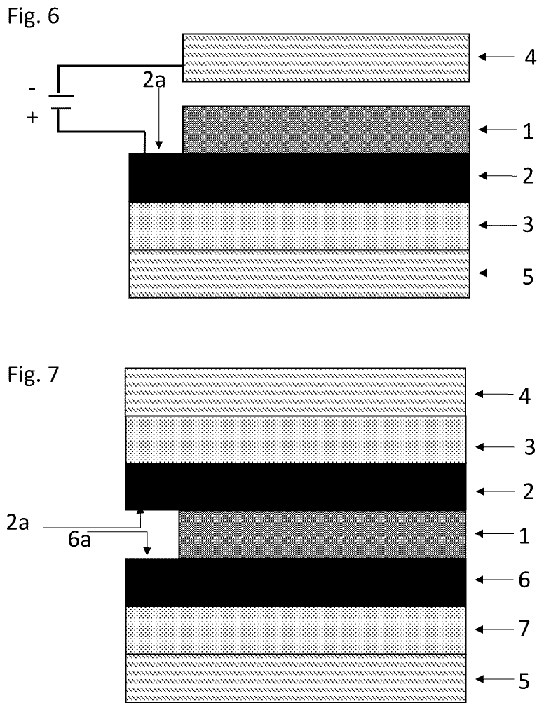

FIG. 6 shows a simplified schematic cross-sectional representation through a bonded composite of the invention after a voltage has been applied and an adhesive split has occurred as a result; and

FIG. 7 shows a simplified schematic cross-sectional representation through a bonded composite of the invention in a preferred embodiment; and

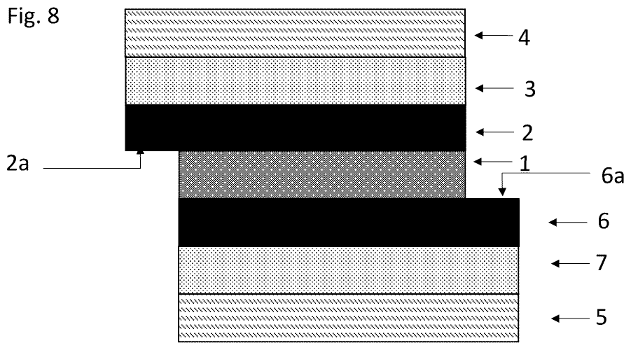

FIG. 8 shows a simplified schematic cross-sectional representation through a bonded composite of the invention in a preferred embodiment.

As can be seen in FIG. 1, the adhesive compound layer D 1 is attached via one of its surfaces to the carrier layer T 2. The second adhesive compound layer C 3 is arranged on the surface of the carrier layer T on the opposite side to the layer D.

As can also be seen in FIG. 1, the layer composite represents a double-sided adhesive tape in which a surface of the adhesive compound layer D and a surface of the second adhesive compound layer C are each available for bonding.

FIG. 2 shows a preferred embodiment of the invention. In this case, the electrically conductive carrier layer T 2 protrudes laterally over the adhesive compound layer D 1 and over the second adhesive compound layer C 3 in at least one direction of extension of the layer plane, such that the electrically conductive carrier layer T 2 includes an overhang having at least one free surface 2 a.

FIG. 3 shows a further preferred embodiment of the invention. In this case, the electrically conductive carrier layer T 2 protrudes laterally over the adhesive compound layer D 1 in at least one direction of extension of the layer plane, such that the electrically conductive carrier layer T 2 includes an overhang having a free surface 2 a. In FIG. 3, the adhesive compound layer C 3 is formed such that it likewise includes an overhang relative to the layer D 1. The carrier layer T 2 is in particular a PET film coated with a metal, such as aluminum or tin, on one side, the metallized side being attached to the layer D 1.

FIG. 4 shows a schematic representation of the bonded composite of the invention in a preferred embodiment. As can be seen from FIG. 4, the adhesive tape is arranged over the adhesive compound layer D 1 on a surface of the first substrate A 4, the first substrate being electrically conductive.

In addition, the adhesive tape is arranged over the second adhesive compound layer C 3 on a surface of a second substrate B 5.

FIG. 4 likewise shows by way of example the lateral protrusion of the electrically conductive carrier layer T 2 over the adhesive compound layer D 1 in at least one direction of extension of the layer plane, such that the electrically conductive carrier layer T includes an overhang having a free surface 2 a.

It is now possible to apply a voltage via this free surface 2a, as shown in the schematic representation in FIG. 5.

Applying the voltage is thought to result in separation of the anions and cations of the ionic liquids, in the adhesive compound layer D 1.

This results in the adhesion of the adhesive compound layer D 1 to the substrate A 4 being greatly reduced and in the debonding of these layers from one another, as can be seen in the schematic representation in FIG. 6.

In FIG. 7, a further schematic representation of the bonded composite of the invention is shown in a preferred embodiment. As can be seen from FIG. 7, the adhesive tape is arranged over the adhesive compound layer C 3 on a surface of the first substrate A 4.

In addition, the adhesive tape is arranged over the third adhesive compound layer C′ 7 on a surface of a second substrate B 5.

Present between the layers C 3 and C′ 7 are the electrically detachable adhesive compound layer D 1 and two electrically conductive carrier layers T 2 and T′ 6, the layer D 1 being arranged between the carrier layers.

FIG. 7 likewise shows by way of example the lateral protrusion of the electrically conductive carrier layer T 2 and of the electrically conductive carrier layer T′ 6 over the adhesive compound layer D 1 in each case in at least one direction of extension of the layer plane, such that the electrically conductive carrier layer T includes an overhang having a free surface 2 a and the electrically conductive carrier layer T′ includes an overhang having a free surface 6a.

In FIG. 8, a further schematic representation of the bonded composite of the invention is shown in a preferred embodiment similar to the representation in FIG. 7. In contrast to FIG. 7, the overhangs of the electrically conductive carrier layer T 2 and the electrically conductive carrier layer T′ 6 are however in different directions, with the result that the resulting free surfaces of these layers 2a and 6a are spatially separated.

It is now possible to apply a voltage via these free surfaces 2a and 6a in analogous manner to FIG. 5. In contrast to the embodiment shown in FIG. 5, the voltage can be applied to surfaces 2a and 6a, which means there is no need for either of substrates A and B to be electrically conductive.

Applying the voltage is thought to result in separation of the anions and cations of the ionic liquids, in the adhesive compound layer D 1. This results in the adhesion of the adhesive compound layer D 1 to the carrier layers T 2 and/or T′ 6 being greatly reduced and in the debonding of these layers from one another. More particularly, detachment occurs at the layer to which the negative pole is applied.

The application of the voltage is simplified in the case of the spatially separated surfaces 2a and 6a as per FIG. 8.

The representations in FIGS. 1 to 8 are schematic representations as shown. In particular, the layer thicknesses of the individual layers D, T, and C may differ from one another. Moreover, the substrates A and B are represented as further layers only schematically. These can of course have any other spatial geometry.

A number of examples are described hereinbelow for further illustration of the invention. The examples marked with “I” are examples of adhesive compounds according to the invention, whereas the examples marked with “C” are comparative examples.

Tables 1 and 2 show the constituents of the monomer compositions of the respective poly(meth)acrylate and of the adhesive compounds whose electrical detachability is to be investigated. The numerical figures represent parts by weight, where 100 parts by weight of the respective poly(meth)acrylate (with the respective monomer composition above) are used and the amounts of further constituents, i.e., of crosslinkers and ionic liquids, are extra additions.

Substances and abbreviations used in Tables 1 and 2
NNDMA: N,N-dimethylacrylamide;
AA: acrylic acid;
4-HBA: 4-hydroxybutyl acrylate;
n-BA: n-butyl acrylate;
2-EHA: 2-ethylhexyl acrylate;
Al chelate: crosslinker: aluminum acetylacetonate, Catana™ CAA 2072, from Sachen;
S610: crosslinker: 1,3-bis(N,N-diglycidylaminomethyl)cyclohexane, from Nantong Synasia Co., Ltd;
N75: crosslinker: Desmodur® N 75 BA, from Covestro;
Irganox® 1010: corrosion inhibitor, pentaerythritol tetrakis(3-(3,5-di-tert-butyl-4-hydroxyphenyl) propionate, from BASF;
BMIM-PF₆: ionic liquid, 1-butyl-3-methylimidazolium hexafluorophosphate;
EMIM-N(CN)₂: ionic liquid, 1-ethyl-3-methylimidazolium dicyanamide, BASIONICS™ VS03, from BASF.

The poly(meth)acrylates were prepared according to the respective monomer composition and otherwise as known to the person skilled in the art.

Illustratively, the preparation of the polymethacrylates is described below with reference to the polymethacrylate from Example 13 (and C3, I4, I5):
A 4 L reactor conventional for radical polymerizations was charged with 204 g of n-butyl acrylate, 72 g of N,N-dimethylacrylamide, 116 g of 2-ethylhexyl acrylate, 8 g of acrylic acid and 400 g of ethyl acetate/isopropanol (96:4). After passage of nitrogen gas through the reactor for 45 minutes with stirring, the reactor was heated to 58° C. and 0.2 g of Vazo® 67 (2,2′-azobis(2-methylbutyronitrile)) was added and the metered addition of the solvent and monomer mixture commenced. The metered addition was over a period of two hours, the mixture having the following composition: 306 g of n-butyl acrylate, 108 g of N,N-dimethylacrylamide, 174 g of 2-ethylhexyl acrylate, 12 g of acrylic acid, and 600 g of ethyl acetate/isopropanol (96:4). The jacket temperature was then heated to 65° C. and the reaction was carried out constantly at this external temperature. After 45 min, the temperature is increased to 72° C. for 2 hours. Before it is reduced after 2 h to 70° C. for the remaining reaction time of 6.25 h. In addition to the initiation at the start of the reaction, 0.3 g of Vazo® 67 is added after 30 min, 0.4 g after 45 min, and 0.4 g after 60 min. To reduce residual monomers, 0.15 g of Perkadox® 16 (di(4-tert-butylcyclohexyl) peroxydicarbonate) was added after 5.5 h and a further 0.1 g after 7 h. The reaction was terminated after 9 h reaction time and the reaction mixture cooled to room temperature. The solution was adjusted to a solids content of 38% by weight.

The adhesive compounds of Tables 1 and 2 were produced as follows: In the case of mixtures of ionic liquids, they were first intensively mixed together on a roller bench in order to achieve a homogeneous distribution.

For Examples 11, 12, 13 and 14 according to the invention, a mixture consisting of 74% by weight of BMIM-PF₆ (PH=5.8) and 26% by weight of EMIM-N(CN)₂ (pH=11) was produced in this manner. The resulting mixture had a pH of 8.

For Example 15 according to the invention, a mixture consisting of 79% by weight of BMIM-PF₆ (pH=5.8) and 21% by weight of EMIM-N(CN)₂ (pH=11) was produced in this manner. The resulting mixture had a pH of 7.5.

To 100 parts by weight based on the amount of the respective poly(meth)acrylate without solvent, the respective ionic liquid or the respective mixture of ionic liquids and the specified crosslinking agent(s) were added.

The resultant mixture was then coated with a coating bar onto a PET liner provided with a silicone release. Afterwards, it was dried at room temperature for 15 minutes and at 120° C. for another 15 minutes. The layer thickness after drying was 60 μm.

Subsequently, the examples in Table 1 were stored for 3 days at 60° C. and the examples in Table 2 were stored for 7 days at 40° C. to ensure full crosslinking.

These adhesive compounds to be investigated in respect of electrical detachability were used to produce inventive examples of the invention and comparative examples for adhesive tapes. The adhesive tapes, 60 μm thick, were laminated onto a tin-coated PET film 25 μm thick. The tin coating of the PET film was in contact with the respective adhesive compound to be examined for electrical detachability.

The adhesive tapes were tested in respect of their electrical detachability based on peel adhesion on steel; the peel adhesion was tested before application of a voltage and further test specimens had a voltage of 9 V applied for 90 seconds before determination of the peel adhesion.

The voltage was applied between the steel substrate and the tin-vapor-coated PET film, with the negative pole applied to the steel substrate and the positive pole applied to the tin foil. Further details regarding the test methods are given in the “Test Methods” section below.

The results are likewise collated in Tables 1 and 2.

All inventive examples show a significant decrease in strength of adhesion when applying a voltage of 9 V for 90 s. The steel plate was in each case free of residues, i.e., remnants of the adhesive compound.

Furthermore, all examples according to the invention show good corrosion resistance, and so there is no need to use a corresponding protective agent (in this case Irganox® 1010). Example 14 shows that the amount of ionic liquids can be further reduced and yet a very good electrical detachability is still achieved.

C1, on the other hand, shows severe corrosion after storage of the samples for just 3 days at 65° C. and 90% RH, and so all further results after prolonged storage could not be determined (n.d.). C2 shows a significant decrease in peel adhesion after storage of the samples for just 3 days at 65° C. and 90% RH and, after storage of the samples for 7 days at 65° C. and 90% RH, shows corrosion. Therefore, the peel adhesion for C2 after 7 days of storage could no longer be determined (also n.d.). C3 after storage of the samples for 7 days at 65° C. and 90% RH also shows corrosion. In addition, a comparatively high content of released hydrofluoric acid is measured for C3, which is undesirable.

TABLE 1

| | Constituents | | | |
|---|---|---|---|---|
| Monomers | C1 | C2 | I1 | I2 |
| NNDMA | 28 | 28 | 28 | 28 |
| 4-HBA | 22 | 22 | 22 | 22 |
| n-BA | 34 | 34 | 34 | 34 |
| 2-EHA | 16 | 16 | 16 | 16 |
| Poly(meth)acrylate A | 100 | 100 | 100 | 100 |
| N75 | 0.3 | 0.3 | 0.3 | 0.3 |
| Irganox ® 1010 | — | 5 | — | 5 |
| BMIM-PF₆ (pH = 5.8) | — | — | 2.96 | 2.22 |
| EMIM-N(CN)₂ (pH = 11) | 4 | 4 | 1.04 | 0.78 |
| Total pH of mixture of all ionic | 11 | 11 | 8 | 8 |
| liquids | | | | |
| Peel adhesion [N/cm] | 5.9 | 7.1 | 5.7 | 5.5 |
| Peel adhesion (9 V, 90 s) [N/cm] | 0.001 | 0.08 | 0.01 | 0.35 |
| Peel adhesion 72 h | 2.2 | 3.1 | 4.2 | 5.3 |
| 65° C., 90% RH [N/cm] | | | | |
| Peel adhesion 72 h | 0.01 | 0.05 | 0.01 | 0.1 |
| 65° C., 90% RH | | | | |
| (9 V, 90 s) [N/cm] | | | | |
| Corrosion 72 h 65° C., 90% RH | Yes | No | No | No |
| [N/cm] | | | | |
| Peel adhesion 168 h | n.d. | n.d. | 4.4 | 5.2 |
| 65° C., 90% RH [N/cm] | | | | |
| Peel adhesion 168 h | n.d. | n.d. | 0.01 | 0.05 |
| 65° C., 90% RH (9 V, 90 s) [N/cm] | | | | |
| Corrosion 168 h 65° C., 90% RH | n.d. | Yes | No | no |
| HF [ppm] | 0 | 0 | 0 | 0 |

TABLE 2

| | Constituents | | | |
|---|---|---|---|---|
| Monomers | C3 | I3 | I4 | I5 |
| NNDMA | 18 | 18 | 18 | 18 |
| AA | 2 | 2 | 2 | 2 |
| n-BA | 51 | 51 | 51 | 51 |
| 2-EHA | 29 | 29 | 29 | 29 |
| Poly(meth)acrylate A | 100 | 100 | 100 | 100 |
| Al chelate | 0.4 | 0.4 | 0.4 | 0.4 |
| S610 | 0.05 | 0.05 | 0.05 | 0.05 |
| Irganox ® 1010 | — | 1 | — | 0.5 |
| BMIM-PF₆ (pH = 5.8) | 7 | 2.96 | 2.74 | 2.96 |
| EMIM-N(CN)₂ (pH = 11) | — | 1.04 | 0.96 | 0.74 |
| Total pH of mixture of all ionic | 5.8 | 8 | 8 | 7.5 |
| liquids | | | | |
| Peel adhesion [N/cm] | 4.5 | 4.7 | 4.4 | 4.7 |
| Peel adhesion (9 V, 90 s) [N/cm] | 0.01 | 0.04 | 0.01 | 0.1 |
| Peel adhesion 72 h | 4.4 | 4.2 | 4.1 | 4 |
| 65° C., 90% RH [N/cm] | | | | |
| Peel adhesion 72 h 65° C., 90% RH | 0.01 | 0.05 | 0.02 | 0.01 |
| (9 V, 90 s) [N/cm] | | | | |
| Corrosion 72 h 65° C., 90% RH | No | No | No | No |
| Peel adhesion 168 h | 4.7 | 4.7 | 4.5 | 4.1 |
| 65° C., 90% RH [N/cm] | | | | |
| Peel adhesion 168 h 65° C., 90% RH | 0.01 | 0.01 | 0.01 | 0.01 |
| (9 V, 90 s) [N/cm] | | | | |
| Corrosion 168 h 65° C., 90% RH | Yes | No | No | No |
| HF [ppm] | >15 | 0 | 0 | 0 |

### Test Methods

Unless otherwise stated, all measurements are carried out at 23° C. and 50% relative humidity. The mechanical and adhesion data were determined as follows:

### K Value

The principle of the method is based on the capillary viscometric determination of the relative solution viscosity. For this, the test substance is dissolved in toluene by shaking for thirty minutes so as to obtain a 1% solution. In a Vogel-Ossag viscometer, the flow time is measured at 25° C. and the relative viscosity of the sample solution determined therefrom in relation to the viscosity of the pure solvent. The K value can be read from tables according to Fikentscher in a manner known to those skilled in the art (K=1000 k).

### DSC

The glass transition points-synonymously referred to as glass transition temperatures—in particular of polymers or polymer blocks are reported as the result of measurements by differential scanning calorimetry (DSC). For this, approx. 5 mg of an untreated polymer sample is weighed into a small aluminum crucible (volume 25 μl) and closed with a perforated lid. A DSC 204 F1 from Netzsch is used for the measurement. Operations are carried out under nitrogen for inertization. The sample is first cooled to −150° C., then heated at a heating rate of 10 K/min to +150° C. and cooled again to −150° C. The subsequent second heating curve is run again at 10 K/min and the change in heat capacity is recorded. Glass transitions are recognized as steps in the thermogram.

### Peel Adhesion, Steel

To test the peel adhesion on steel of the layer to be investigated for electrical detachability: A 20 mm wide strip of the adhesive tape comprising the adhesive compound to be investigated for electrical detachability and the 25 μm thick tin-coated PET film was applied to a steel plate which was previously washed twice with acetone and once with isopropanol. The adhesive strip is pressed onto the substrate twice with a contact pressure corresponding to a weight of 2 kg.

The adhesive tape is peeled off after a mounting time of 20 minutes at 23° C. and 50% RH (relative humidity) or after a mounting time of 3 days at 65° C. and 90% RH followed by a 2-hour reacclimatization period at 23° C. and 55% RH, or after 7 days (168 hours) at 65° C. and 90% RH with a subsequent reacclimatization period of 2 hours at 23° C. and 55% RH, in each case with a speed of 300 mm/min and at an angle of 180° from the substrate. All measurements are carried out at room temperature.

The test results are reported in N/cm and are the average of three measurements. For measuring the peel adhesion after applying a voltage, the adhesive tape is adhered to the steel plate as described above and the respective mounting time, storage and reacclimatization under the stated conditions are observed. A DC voltage of 9 V is applied, with the negative pole positioned on the steel plate and the positive pole positioned on the tin-coated film.

After 90 s, the voltage is switched off and the sample is immediately clamped into the measuring apparatus and the strength of adhesion measured.

### Corrosion Behavior

When evaluating the corrosion behavior, the corresponding specimen is stored for 72 h or 168 h at 65° C. and 90% RH as a strip of 2 cm width and then visually examined. Corrosion of the metal layer, in this case tin layer, can then be evaluated immediately.

### Thickness

The thickness of an adhesive compound layer can be determined by determining the thickness of a section, defined in terms of its length and width, of such an adhesive compound layer applied to a liner, minus the (known or separately determinable) thickness of a section of the same dimensions of the liner used. The thickness of the adhesive compound layer can be determined with accuracies of less than 1 μm deviation using commercially available thickness measuring devices (sensor test devices). If thickness fluctuations are detected, the mean value of measurements at not fewer than three representative locations is reported; thus, in particular, measurement is not performed at creases, folds, nibs and the like.

As already described above for the thickness for an adhesive compound layer, it is likewise possible to determine in analogous manner the thickness of an adhesive tape (adhesive strip) or of a carrier with accuracies of less than 1 μm deviation using commercially available thickness measuring devices (sensor test devices). If thickness fluctuations are detected, the mean value of measurements at not fewer than three representative locations is reported; thus, in particular, measurement is not performed at creases, folds, nibs and the like.

### pH

To measure the pH of a pure ionic liquid or a mixture of two or more ionic liquids, a pH meter (Mettler Toledo FiveEasy Plus™, from Mettler Toledo) is used. This is first calibrated with standard buffers (pH 4.01 and 7 and 9.21) and the electrode is rinsed with distilled water between the individual steps. The ionic liquid or the mixture is gently stirred to ensure uniform distribution before the rinsed electrode of the PH meter is inserted and the instrument can stabilize before the reading is recorded.

### HF (Hydrofluoric Acid) Test

To measure the release of hydrogen fluoride gas (HF) resulting from the thermal decomposition of BMIM-PF₆ in a solvent-based acrylic, a systematic method was performed. 6 plates with dimensions of 300 mm*400 mm and a thickness of 60 μm were coated. The samples were initially dried at 80° C. for 10 minutes to remove residual solvent. Subsequently, the samples were heated gradually from 100° C. to 250° C. in 10° C. steps in a controlled oven. At each temperature step, the HF gas concentration was measured with a Dräger HF detection tube (range 0.5-15 ppm, resolution 0.5 ppm; model 81 03 251) connected to a manual Accuro gas pump via a temperature reduction tube.

### LIST OF REFERENCE SIGNS

1 Adhesive compound layer D
2 Electrically conductive carrier layer T
2a Free surface of electrically conductive carrier layer T
3 Second adhesive compound layer C
4 First substrate A
Second substrate B
6 Second electrically conductive carrier layer T′
6a Free surface of electrically conductive carrier layer T′
7 Third adhesive compound layer C′

1. An adhesive compound comprising
a) at least one first ionic liquid which has a pH of less than or equal to 7, and
b) at least one second ionic liquid which has a pH of greater than 7,
wherein a pure mixture of all ionic liquids contained in the adhesive compound and a) having a pH of less than 7 and b) having a pH of greater than 7 has a pH of 5.5 to 9.

2. The adhesive compound as claimed in claim 1, wherein
the pure mixture of the ionic liquids a) and b) has a pH value of 6.5 to 9.

3. The adhesive compound as claimed in claim 1, which comprises as first ionic liquid a) an ionic liquid having a pH of less than or equal to 7, wherein this ionic liquid a) comprises an imidazolium-based cation and/or this ionic liquid a) comprises an anion selected from the group consisting of the anions hexafluorophosphate (PF₆⁻), bis(trifluoromethylsulfonyl)imide (CF₃SO₂) ₂N⁻, TFSI), bis(fluorosulfonyl)imide ((FSO₂) ₂N⁻, FSI), trifluoromethanesulfonate (CF₃SO₃⁻, OTf, triflate), acetate (CH₃COO⁻), methylsulfate (CH₃OSO₃⁻), tetrafluoroborate (BF₄⁻), thiocyanate (SCN⁻), benzoate and dicyanamide (N(CN)₂⁻).

4. The adhesive compound as claimed in claim 1, which comprises as first ionic liquid a) having a pH of less than or equal to 7 at least one ionic liquid selected from the group consisting of 1-butyl-3-methylimidazolium hexafluorophosphate (BMIM-PF₆), 1-ethyl-3-methylimidazolium bis(fluorosulfonyl)imide (EMIM-FSI), 1-butyl-3-methylimidazolium bis(fluorosulfonyl)imide (BMIM-FSI) and 1-butyl-3-methylimidazolium benzoate (BMIM benzoate).

5. The adhesive compound as claimed in claim 1, which comprises as second ionic liquid b) an ionic liquid having a pH of greater than 7, wherein this ionic liquid b) comprises a cation selected from the group consisting of imidazolium-based cations and pyrrolidinium-based cations and/or this ionic liquid b) comprises an anion selected from the group consisting of the anions acetate (CH₃COO⁻), ethylsulfate (CH₃CH₂OSO₃⁻), diethylphosphate, octanoate, benzoate, tricyanomethanide (C(CN)₃⁻) and dicyanamide (N(CN)₂⁻).

6. The adhesive compound as claimed in claim 1, which comprises as second ionic liquid b) having a pH of greater than 7 at least one ionic liquid selected from the group consisting of
₂),
diethylphosphate and 1-ethyl-3-methylimidazolium ethylsulfate, wherein 1-ethyl-3-methylimidazolium dicyanamide (EMIM-N(CN)₂) is particularly preferred.

7. The adhesive compound as claimed in claim 1, wherein the adhesive compound comprises at least one poly(meth)acrylate.

8. The adhesive compound as claimed in claim 7, wherein the poly(meth)acrylate is based on a monomer composition which contains more than 15% by weight of at least one acrylamide as nitrogen-containing (meth)acrylate monomer, wherein the acrylamide is optionally selected from the group consisting of
dimethyl-aminopropylacrylamide, dimethylaminopropylmethacrylamide, butoxymethyl) acrylamide,
butoxymethyl) methacrylamide, N-(ethoxymethyl) acrylamide,
dialkyl-substituted amides such as
dimethylmethacrylamide, N,N-diethylacrylamide and N,N-diethylmethacrylamide, N-benzylacrylamide,
butylacrylamide, N-tert-octylacrylamide,
methylolacrylamide, N-methylolmethacrylamide, and more preferably selected from the group consisting of N, N-dimethylacrylamide and N, N-diethylacrylamide.

9. The adhesive compound as claimed in claim 7, wherein the monomer composition contains 5% to 35% by weight of at least one hydroxyl-containing (meth)acrylate monomer, wherein the hydroxyl-containing (meth)acrylate monomer is optionally selected from the group consisting of 4-hydroxybutyl acrylate, 2-hydroxyethyl acrylate, 2-hydroxypropyl acrylate, 2-hydroxybutyl acrylate, 2-hydroxyethyl methacrylate, 2-hydroxypropyl methacrylate, 2-hydroxybutyl methacrylate, 2-hydroxyisopropyl acrylate, 2-hydroxyethylacrylamide.

10. The adhesive compound as claimed in claim 7, wherein the monomer composition contains 5% to 85% by weight of at least one (meth)acrylate monomer without further functional groups, which is selected from the group consisting of n-butyl acrylate, n-butyl methacrylate, n-pentyl acrylate, n-pentyl methacrylate, n-hexyl acrylate,
n-nonyl acrylate, isobutyl acrylate, isooctyl acrylate, isooctyl methacrylate,

11. An adhesive tape comprising at least one adhesive compound layer D of an adhesive compound as claimed in claim 1.

12. The adhesive tape as claimed in claim 11, wherein the adhesive tape is an adhesive transfer tape and consists of the adhesive compound layer D.

13. The adhesive tape as claimed in claim 11, further comprising at least the following layers:
a second adhesive compound layer C; and
at least one electrically conductive carrier layer T that is arranged between layers D and C.

14. The adhesive tape as claimed in claim 11, further comprising at least the following layers:
a second adhesive compound layer C; and
at least one first electrically conductive carrier layer T that is arranged between the layers D and C; and
at least one second electrically conductive carrier layer T′ that is arranged on the surface of the adhesive compound layer D on the opposite side to the first electrically conductive carrier layer T; and
a third adhesive compound layer C′ that is arranged on the surface of the second carrier layer T′ on the opposite side to the first adhesive compound layer D.

15. A bonded assembly comprising at least the following layers:
a first substrate A; and
a second substrate B; and
an adhesive tape as claimed in claim 11 that is arranged between the substrate A and the substrate B and bonds the substrates A and B to one another, wherein, in particular, either the substrate A and the substrate B or at least one of the substrates and the adhesive tape, at not less than one point, or none of the substrates and the adhesive tape, at two different points, are designed to be electrically conductive.

16. A method for electrically debonding the assembly as claimed in claim 15, comprising at least the following method step:
i.) applying a voltage at two different electrically conductive points of the assembly, the voltage being preferably from 1 to 50 V.

17. A method of bonding of components in electronic devices, automobiles, medical devices and dental devices which comprises applying the adhesive compound as claimed in claim 1 to the components.

18. The adhesive compound as claimed in claim 2, wherein
the pure mixture of the ionic liquids a) and b) has a pH value from 7 to 9; 7 to 8.5; 7.3 to 8.2; or 7.5 to 8.

19. The adhesive compound as claimed in claim 4, wherein the first ionic liquid a) having a pH of less than or equal to 7 is least one ionic liquid selected from the group consisting of 1-butyl-3-methylimidazolium hexafluorophosphate (BMIM-PFs) and 1-ethyl-3-methylimidazolium bis(fluorosulfonyl)imide (EMIM-FSI) or is 1-butyl-3-methylimidazolium hexafluorophosphate (BMIM-PF₆).

20. The adhesive compound as claimed in claim 6, wherein the second ionic liquid b) having is 1-ethyl-3-methylimidazolium dicyanamide (EMIM-N(CN)₂).
